(19) United States
(12) Patent Application Publication
(10) Pub. No.: US 2026/0134332 A1
(43) Pub. Date: May 14, 2026

(54) SCORING AND EVALUATION ANALYSIS FOR LARGE LANGUAGE SYSTEMS

(71) Applicant: Workday, Inc., Pleasanton, CA (US)

(72) Inventor: Tamilselvan Tamilmani, Fremont, CA (US)

(21) Appl. No.: 18/942,190

(22) Filed: Nov. 8, 2024

(51) Int. Cl. G06N 20/00

(52) U.S. Cl. CPC G06N 20/00

(57) ABSTRACT

A system, method, and device for configuring a machine learning model to operate within boundaries based on a ground truth associated with a dataset for which the machine learning model is to be deployed are provided. The method determines a ground truth dataset of questions and answers for use in configuring the machine learning model. The method includes (i) obtaining a use case dataset for which a first machine learning model is to be configured, (ii) obtaining a ground truth dataset for configuring the first machine learning model, the ground truth dataset being obtained based at least in part on querying a second machine learning model based on the use case dataset, (iii) configuring the first machine learning model based on the ground truth dataset, and (iv) deploying the first machine learning model.

### BACKGROUND OF THE INVENTION

In recent years, large language models (LLMs) have transformed the landscape of artificial intelligence by enabling machines to understand and generate human-like text. These models have found applications in various domains, including customer service, content creation, and data analysis. However, deploying LLMs within an organizational context presents unique challenges. Organizations often possess proprietary or sensitive corpora that require careful handling to maintain confidentiality and comply with legal and regulatory standards. Additionally, standard LLMs may produce outputs that are biased, toxic, or hallucinatory, which can lead to misinformation or violate company policies, ethical guidelines, and/or legal or regulatory requirements.

### BRIEF DESCRIPTION OF THE DRAWINGS

Various embodiments of the invention are disclosed in the following detailed description and the accompanying drawings.

FIG. 1 is a block diagram of a network system according to various embodiments.

FIG. 2 is a block diagram of a user interface service for configuring a user interface for managing implementation of a model according to various embodiments.

FIG. 3 is a block diagram of a ground truth generation service according to various embodiments of the present application.

FIG. 4 is a block diagram of a corpus determination service according to various embodiments.

FIG. 5 is a block diagram of a question and answer generation service according to various embodiments.

FIG. 6 is a block diagram of a ground truth quality evaluation service according to various embodiments.

FIGS. 7A and 7B are diagrams of representations of ground truth evaluations according to various embodiments.

FIG. 8 is a block diagram of a ground truth evaluation service according to various embodiments.

FIG. 9 is a block diagram of a user interface service for configuring an organization-specific model according to various embodiments.

FIG. 10 is a block diagram of a reporting and monitoring service for evaluating a model according to various embodiments.

FIGS. 11A-11C are user interfaces configured in connection with determining a ground truth for a set of documents or files according to various embodiments.

FIGS. 12A-12G are user interfaces configured in connection with determining a ground truth for a set of documents or files according to various embodiments.

FIG. 13 is a flow diagram of a method for deploying a machine learning model for a particular use case according to various embodiments.

FIG. 14 is a flow diagram of a method for training a first machine learning model to be deployed for a particular use case according to various embodiments.

FIG. 15 is a flow diagram of a method for determining a ground truth dataset for a particular use case according to various embodiments.

FIG. 16 is a flow diagram of a method for determining a corpus for a particular use case according to various embodiments.

FIG. 17 is a flow diagram of a method for determining a ground truth dataset for a particular use case according to various embodiments.

FIG. 18 is a flow diagram of a method for evaluating a ground truth dataset according to various embodiments.

FIG. 19 is a flow diagram of a method for updating a deployed machine learning model according to various embodiments.

FIG. 20 is a flow diagram of a method for generating a ground truth dataset for a particular use case according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, a first machine learning model may include a machine learning model that is configured to be deployed for a particular use case, such as to provide coverage for a corresponding corpus. The first machine learning model may be a large language model (LLM).

As used herein, a second machine learning model may include a machine learning model that is used in connection with generating a ground truth dataset (e.g., the ground truth dataset can be used to configure/train the first machine learning model). The second machine learning model may be an LLM.

Various embodiments address these challenges of deploying LLMs within an organizational context by providing a method for configuring an LLM (e.g., a first machine learning model) specifically to generate insights from an organization-specific corpus while operating within defined boundaries. In some embodiments, this is achieved by generating a ground truth dataset (e.g., based at least in part on querying a second machine learning model, which may be an LLM) comprising questions and answers pertinent to the corpus. The ground truth dataset is thoroughly evaluated to ensure it sufficiently covers the scope of the corpus and adheres to boundaries related to content, bias, toxicity, hallucination tendencies, and legal or regulatory requirements. The ground truth dataset can be iteratively updated to enhance coverage and alignment with these boundaries, which may change through a change/drift in the corpus scope or legal or regulatory requirements. The LLM is then trained or configured based on this refined dataset, resulting in a model that delivers accurate, relevant, and compliant insights. This approach ensures that the LLM effectively serves the organization's needs while upholding standards of integrity and responsibility.

Various embodiments include a method and system for configuring, deploying, and maintaining a large language model (LLM) that generates insights specifically tailored to an organization's proprietary corpus of data. The primary objective is to enable the LLM to operate effectively within predefined boundaries that address concerns such as content relevance, bias, toxicity, hallucination tendencies, and compliance with legal or regulatory requirements—even as the corpus evolves over time.

The process begins with the creation of a ground truth dataset composed of questions and answers relevant to the organization's initial corpus. This ground truth dataset serves as foundational training material, ensuring that the LLM is exposed to the specific topics, terminologies, and contexts pertinent to the organization's domain. The questions and answers are meticulously crafted to cover the full scope of the corpus (e.g., to encompass all essential areas the LLM needs to understand).

Once the initial ground truth dataset is generated, it undergoes a thorough evaluation to assess its coverage and alignment with the predefined boundaries. This involves analyzing the dataset to identify any gaps in content coverage, instances of potential bias or toxicity, and elements that might lead to hallucinations—where the LLM generates information not grounded in the corpus. The evaluation also ensures compliance with all applicable legal and regulatory standards relevant to the organization.

If the evaluation reveals deficiencies or areas for improvement, the ground truth dataset is updated accordingly. This iterative process may involve adding new questions and answers to address uncovered topics, rephrasing existing entries to eliminate bias or toxicity, and modifying content to meet legal or regulatory requirements. The goal is to refine the dataset until it provides comprehensive coverage of the corpus while strictly adhering to the established boundaries.

With the refined ground truth dataset, the LLM is then trained or configured. Training adjusts the LLM's parameters (or configures the LLM context window) so that the LLM learns to generate responses that accurately reflect the corpus content and stay within the defined boundaries. Techniques such as supervised learning (e.g., where the LLM learns directly from the ground truth dataset) and/or reinforcement learning (e.g., where it is further adjusted based on performance feedback) may be implemented.

According to various embodiments, the system is adaptable to changes in the organization's corpus over time. Organizations continually evolve, adding new documents or incorporating different types of information into their corpus, such as new product data, research findings, policy updates, or regulatory changes. These additions can shift the scope of the corpus, introducing new topics, terminologies, and contexts that the LLM should understand to remain effective.

To address this, various embodiments include a mechanism for continuous monitoring of the corpus for any changes or additions. When significant changes are detected (e.g., such as the inclusion of new document types or information with different characteristics), the ground truth dataset is updated to reflect the expanded scope. This can involve generating new questions and answers pertinent to the new content, ensuring that the dataset maintains comprehensive coverage of the corpus in its current state.

The updated ground truth dataset is then re-evaluated to ensure it still aligns with the predefined boundaries. This mechanism checks for any new instances of bias, toxicity, hallucination tendencies, or compliance issues that may have been introduced with the new content. Any identified issues are addressed through further refinement of the ground truth dataset.

According to various embodiments, following the update and evaluation of the ground truth dataset, the LLM is reconfigured or retrained. This retraining process incorporates new information, allowing the LLM to adjust its understanding and generate insights that are accurate and relevant to the updated corpus. Retraining ensures that the LLM remains aligned with the organization's current knowledge base and continues to operate within the established boundaries.

Throughout the deployment of the LLM, continuous monitoring and evaluation of its outputs are conducted. This ongoing assessment checks for adherence to the boundaries and detects any undesirable behaviors, such as generating biased, toxic, or hallucinatory content, especially in light of the updated corpus. If such issues are detected, the LLM undergoes additional training or reconfiguration using the latest ground truth dataset or adjusted parameters to correct these behaviors.

Various embodiments provide a dynamic and systematic approach for organizations to leverage LLMs effectively while adapting to changes in their proprietary corpus. By focusing on the generation and iterative refinement of a ground truth dataset that evolves with the corpus, and by retraining the LLM as needed, the method ensures that the LLM delivers valuable insights that are accurate, relevant, and compliant with the organization's standards and regulatory obligations. This adaptability enhances the utility of LLMs in organizational settings, enabling them to function as reliable tools for information retrieval, decision support, and knowledge management, even as the organization's information landscape changes over time.

The system and/or process according to various embodiments improves on related art systems that deploy LLMs for a particular organization use case, such as by providing the ability to automate the testing and monitoring process end to end, making the system/process scalable and accessible to end-users. The system and/or process is implemented to increase confidence in generative artificial intelligence (GenAI) systems (e.g., deployed LLMs) by addressing the gap in the current generative artificial intelligence (AI) ecosystem, which stems from the unbounded response of GenAI systems coupled with the evolving regulatory landscape, and the lack of qualified personnel to address these challenges. The regulations may make it mandatory for organizations or GenAI developers to address toxicity, bias, ethical, and other societal assessments along with accuracy in GenAI solutions.

The system empowers end-users, such as by enabling the end-users to conduct testing themselves. In addition, the system provides a comprehensive testing mechanism, such as by evaluating LLMs across multiple dimensions (e.g., along one or more different metrics), ensuring accuracy, safety, and unbiased responses. Moreover, the system generates (and can provide to a user via a user interface) a statistical representation and topic coverage, such as by providing a statistical representation of generated questions, ensuring a good mix that challenges the LLM and covers the entire corpus of documents. The system additionally implements an end-to-end workflow and reporting, such as by implementing a seamless workflow from question generation (e.g., generation of the ground truth dataset) to reporting, allowing users to monitor and take corrective actions.

Various embodiments provide a system, method, and/or device for configuring a machine learning model to operate within boundaries based on a ground truth associated with a dataset for which the machine learning model is to be deployed. The method determines a ground truth dataset of questions and answers for use in configuring the machine learning model. The method includes (i) obtaining a use case dataset for which a first machine learning model is to be configured, (ii) obtaining a ground truth dataset for configuring the first machine learning model, the ground truth dataset being obtained based at least in part on querying a second machine learning model based on the use case dataset, (iii) configuring the first machine learning model based on the ground truth dataset, and (iv) deploying the first machine learning model.

Various embodiments provide a system, method, and/or device for determining a ground truth dataset to be used in connection with configuring a machine learning model to operate within boundaries based on a corpus for a use case dataset. The method includes (i) obtaining a use case dataset for which a first machine learning model is to be configured, (ii) processing the use case dataset to obtain a corpus associated with a use case for which the first machine learning model is to be deployed, (iii) querying a second machine learning model to generate a ground truth dataset based at least in part on the corpus, (iv) configuring the ground truth dataset based at least in part on an evaluation associated with the ground truth dataset, and (v) providing the ground truth dataset.

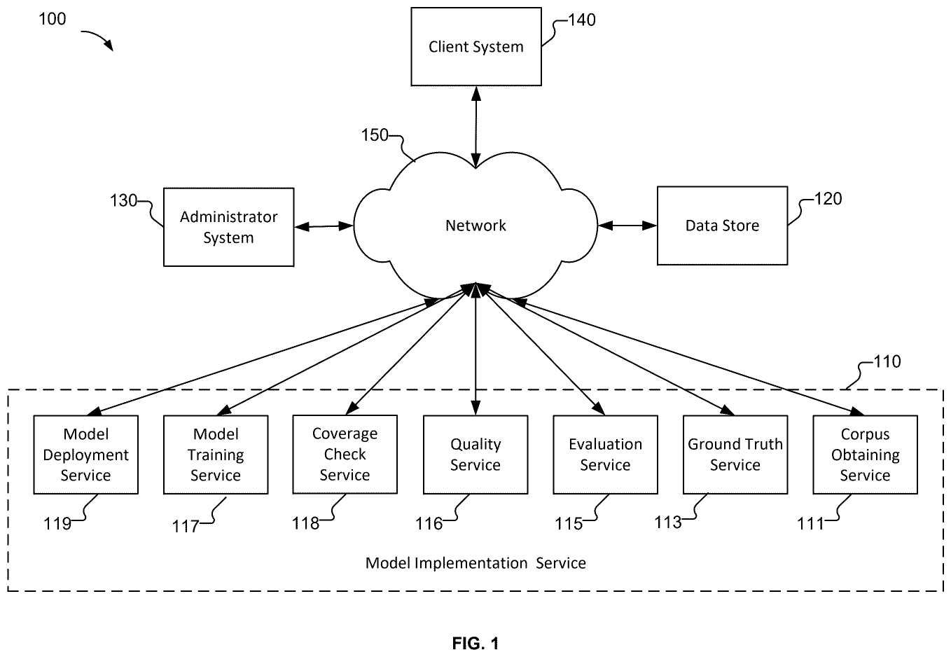

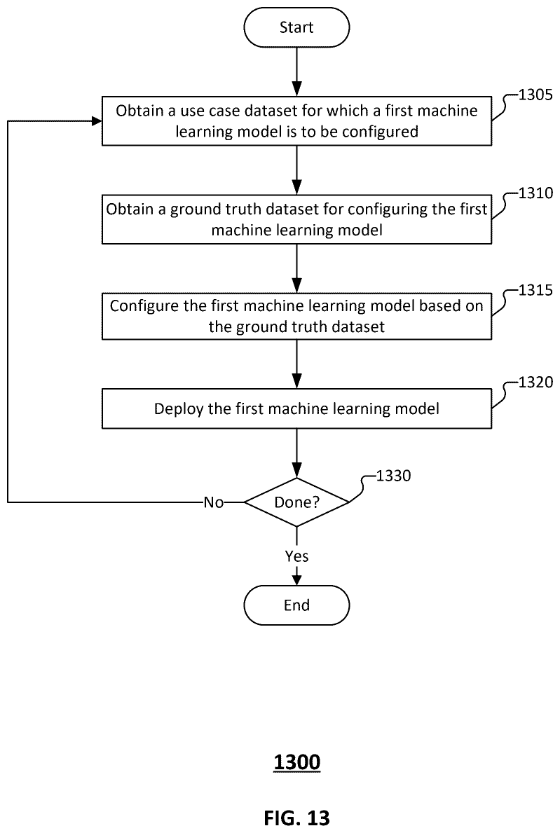

FIG. 1 is a block diagram of a network system according to various embodiments. In some embodiments, system 100 is implemented at least in part by user interface service 200. System 100 may implement one or more of processes 1300-2000 of FIGS. 13-20.

In the example shown, system 100 comprises model implementation service 110. In some embodiments, model implementation service 110 is configured to develop, train, and/or refine a first machine learning model (e.g., the target LLM) to be deployed for a particular use case, such as a use case associated with a scope of (e.g., a knowledge base comprised in) the use case dataset. As illustrated, model implementation service 110 may include one or more of corpus obtaining service 111, ground truth service 113, evaluation service 115, quality service 116, coverage check service 118, model training service 117, and/or model deployment service 119.

System 100 may additionally include one or more data stores, such as data store 120, and network 150 over which one or more of model implementation service 110, client system 140, administrator system 130, and data store 120 are connected. In some embodiments, model implementation service 110 is implemented by a plurality of servers. In various embodiments, network 150 includes one or more of a wired network and/or a wireless network such as a cellular network, a wireless local area network (WLAN), or any other appropriate network. System 100 may include various other systems or terminals.

According to various embodiments, system 100 (e.g., model implementation service 110) obtains a use case dataset. The use case dataset can comprise a set of documents that are representative of a use case for which the first machine learning model (e.g., a target LLM or target GenAI system/model) is to be deployed. For example, the use case can be organization or customer specific. As an example, the use case dataset may be obtained from data store 120 or a third party service, and/or via an upload from a user (e.g., an organization administrator may upload, or provide model implementation service 110 with, the use case dataset). Documents comprised in the use case dataset can be manually uploaded and/or automatically gathered from designated sources through an established pipeline. The use case dataset can include a diverse collection of documents in various formats such as PDFs, word documents, presentations, diagrams, and images. This range of formats mirrors the real-world situation, where information is often spread across different sources and mediums. These documents form the knowledge base from which model system 100 (e.g., model implementation service 110) generates a ground truth dataset, which may comprise question-and-answer (Q/A) pairs obtained based on, or extracted from, the ground truth dataset. In some embodiments, the use case dataset corresponds to (e.g., comprises) the same documents to be utilized by the first machine learning model (e.g., the LLM to be deployed) when answering user queries.

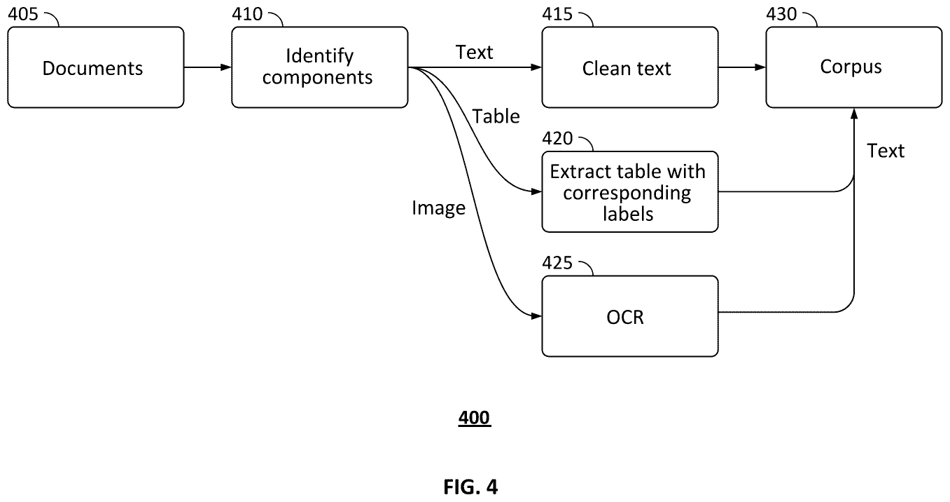

In some embodiments, model implementation service 110 comprises corpus obtaining service 111. Model implementation service 110 uses corpus obtaining service 111 to obtain a corpus associated with a use case for which the first machine learning model (e.g., LLM being trained for deployment) is to be deployed. Corpus obtaining service 111 obtains (e.g., collects) the use case dataset and obtains (e.g., determines) the corpus associated with the use case dataset based on processing the documents or files comprised in the use case dataset, extracting information (e.g., text-based information) from the documents or files, and aggregating and/or analyzing the extracted information to determine the corpus. The determining of the corpus according to various embodiments is further described in connection with FIG. 4.

In some embodiments, model implementation service 110 comprises ground truth service 113. Model implementation service 110 uses ground truth service 113 to obtain a ground truth dataset associated with the use case dataset. For example, model implementation service 110 uses ground truth service 113 to automate the generation of a ground truth dataset. The ground truth dataset may be obtained based at least in part on a corpus obtained by corpus obtaining service 111. In some embodiments, the ground truth dataset comprises a set of questions that serve as a benchmark to evaluate the performance of the machine learning model being configured by model implementation service 110 for deployment (e.g., the first machine learning model, or target LLM) and the machine learning model's ideal answers. The ground truth dataset may additionally comprise a set of answers associated with the set of questions. This set of answers can also serve as a benchmark to evaluate answers generated by the first machine learning model when queried based on the set of questions comprised in the ground truth dataset.

Ground truth service 113 can implement various methods to create diverse and comprehensive questions (and in some implementations, answers) that cover the entire corpus. In some embodiments, ground truth service 113 generates (e.g., determines) the ground truth dataset (e.g., the set of questions and/or answers) based on a second machine learning model. For example, ground truth service 113 queries the second machine learning model for the ground truth dataset. Ground truth service 113 queries the second machine learning model based on the corpus. In some embodiments, the second machine learning model is an LLM, such as a pre-trained LLM. As an example, the second machine learning model may be pre-trained to have a broader knowledge base than the corpus. The second machine learning model may be comprised in ground truth service 113 or may be stored elsewhere and exposed to ground truth service. For example, the second machine learning model may be provided by a third-party service for which ground truth service 113 can be configured to interface.

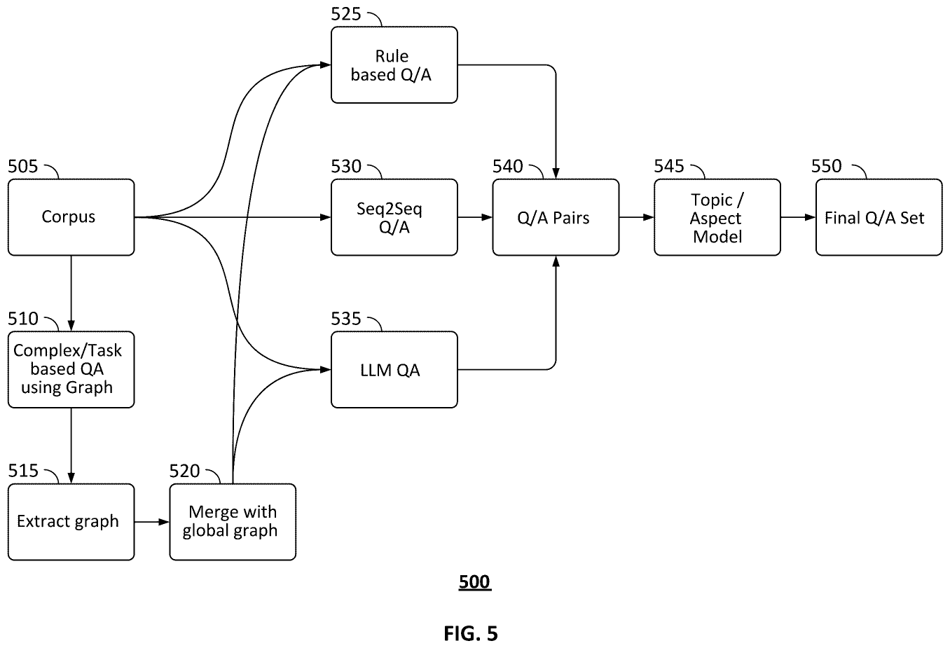

The determining of the ground truth dataset according to various embodiments is further described in connection with FIG. 5.

In response to obtaining the ground truth dataset (e.g., based on querying the second machine learning model), model implementation service 110 can evaluate the ground truth dataset along one or more metrics (e.g., one or more predefined metrics) using a combination of quality service 116 and coverage check service 118 to determine the quality and coverage of the generated Q/A pairs. In some embodiments, model implementation service 110 determines whether the ground truth dataset is insufficient using a combination of quality service 116 and coverage check service 118. In response to determining that the ground truth dataset is insufficient (e.g., along at least one of the one or more metrics), model implementation service 110 can invoke ground truth service 113 to update (e.g., refine, improve, etc.) the ground truth dataset. Model implementation service 110 can iteratively update and evaluate the ground truth dataset until the ground truth dataset is determined to satisfy one or more predefined criteria (e.g., one or more predefined thresholds) for the one or more metrics.

In some embodiments, model implementation service 110 uses a combination of quality service 116 and coverage check service 118 to determine the quality and coverage of the generated Q/A pairs to evaluate the ground truth dataset obtained by ground truth service 113 and to evaluate the target LLM (e.g., the first machine learning model trained by model training service 117). Quality service 116 and coverage check service 118 can evaluate the ground truth dataset and/or the LLM based on one or more of (i) obtaining user input/feedback, and (ii) executing one or more predefined processes or services. As an example, quality service 116 and coverage check service 118 provide (e.g., sends to, or causes a use interface to display) the generated questions and answers comprised in the ground truth dataset to user(s), such as subject matter experts (SMEs), for review to ensure their accuracy and relevance. Quality service 116 and coverage check service 118 can receive input or feedback from the user(s) and update an evaluation accordingly. For example, quality service 116 and coverage check service 118 can determine whether the ground truth dataset (e.g., the set of questions and/or answers) satisfies one or more predefined criteria (e.g., thresholds) for one or more metrics or otherwise determines whether the ground truth dataset satisfies requirements for training the target LLM (e.g., the first machine learning model being trained by model training service 117). Quality service 116 and coverage check service 118 or model deployment service 119 can provide results of the evaluation(s) to model implementation service 110, which can coordinate an update (e.g., refinement or improvement) to the ground truth dataset.

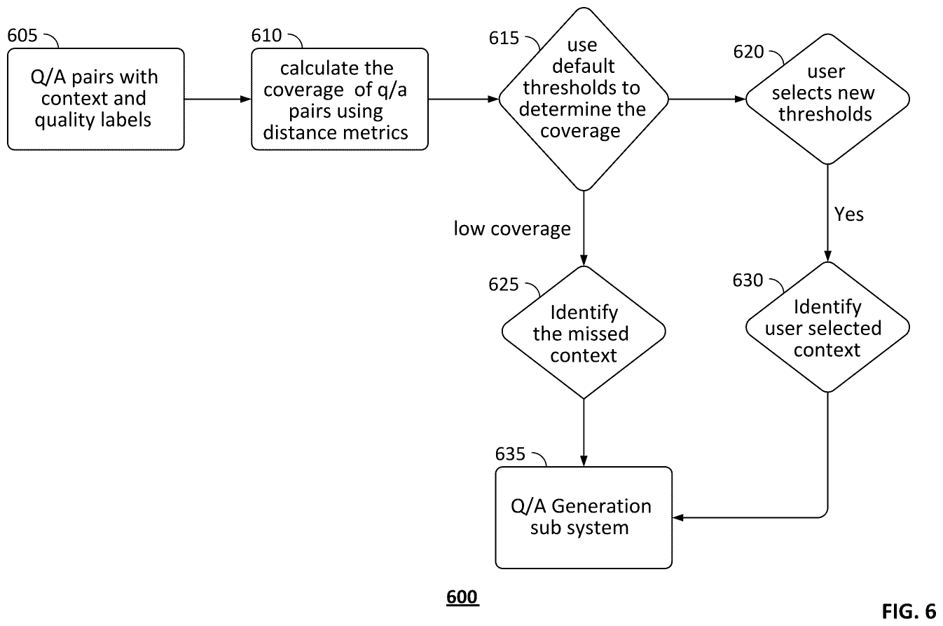

A further description of example embodiments for obtaining (e.g., generating or determining) and evaluating the ground truth dataset is provided in connection with Q/A generation service 500 and/or quality evaluation service 600 of FIGS. 5 and 6.

In some embodiments, model implementation service 110 similarly uses evaluation service 115 to evaluate machine learning models, such as machine learning models being trained (e.g., the first machine learning model, or target LLM) and/or a deployed machine learning model. Model implementation service 110 can invoke an update (e.g., re-training, refining, improvement) to the machine learning models (e.g., models being trained or models that have already been deployed) based on the evaluation by evaluation service 115.

According to various embodiments, evaluation service 115 evaluates LLM responses across multiple metrics (e.g., dimensions). The metrics may include coverage metrics or usability-related metrics. The coverage metrics can measure the extent to which the set of questions and/or answers covers the corpus, such as the coverage of the various types of documents comprised in the corpus, the topics or material comprised in the corpus, etc. Examples of usability-related metrics include accuracy, hallucination, and faithfulness and societal measures include bias and toxicity. A further description of these useability-related metrics is provided in Table 1 below. Various other coverage metrics and/or usability-related metrics may be implemented.

TABLE 1
Usability-related metrics

| Metric | Description |
|---|---|
| Accuracy | Measures how closely the LLM answers |
| | match the ground truth answers |
| Hallucination | Evaluates the LLM tendency to generate |
| | factually incorrect or nonsensical responses |
| Faithfulness | Assesses whether the LLM answers are |
| | consistent with the information provided in |
| | the source documents |
| Bias | Detects any unintended biases in the LLM's |
| | responses, such as gender, racial, age, |
| | disability, political and cultural biases |
| Toxicity | Identifies any harmful or offensive language |
| | in the LLM output |

According to various embodiments, model implementation service 110 (e.g., evaluation service 115) can select an appropriate set of one or more metrics for each dimension based at least in part on the specific use and domain. This selection of the appropriate metrics to be implemented enables customization and refinement based on user feedback. In some embodiments, model implementation service 110 automatically selects the appropriate set of one or more metrics along which a machine learning model is to be evaluated. For example, the set of one or more metrics may be automatically selected based on one or more predefined criteria for the machine learning model being evaluated or one or more predefined criteria for a performance of the machine learning model along a set of dimensions.

According to various embodiments, evaluation service 115 evaluates a machine learning model (e.g., a target LLM being trained for deployment or an already deployed machine learning model) based at least in part on the ground truth dataset. For example, evaluation service 115 obtains a set of questions from the ground truth dataset and prompts the machine learning model based on the set of questions. Evaluation service 115 obtains a set of responses from the machine learning model and evaluates the performance of the machine learning model based at least in part on the set of responses. For example, evaluation service 115 can evaluate the performance of the machine learning model along the one or more dimensions/metrics based on the set of responses. In some embodiments, evaluation service 115 evaluates the performance of the machine learning model based on a comparison of the set of responses relative to a set of answers comprised in the ground truth dataset.

In some embodiments, model implementation service 110 comprises model training service 117. Model implementation service 110 uses model training service 117 to train a machine learning model, such as a target LLM (e.g., the first machine learning model). Model training service 117 can be invoked to train a machine learning model to be deployed or to re-train or refine a deployed machine learning model, such as based on a determination that a corpus on which the deployed machine learning model had been trained has changed (e.g., corpus drift) or that the performance of the deployed machine learning model along one or more dimensions/metrics is insufficient (e.g., does not satisfy one or more predefined criteria or thresholds).

According to various embodiments, model training service 117 trains (or re-trains/refines) a machine learning model based at least in part on the ground truth dataset. For example, model training service 117 obtains a set of questions from the ground truth dataset and prompts the machine learning model based on the set of questions. Model training service 117 can train the machine learning model by providing feedback on a set of responses it receives from the machine learning model in response to the prompting based on the set of questions. For example, in response to determining that a response to a question is an ideal answer (e.g., satisfies one or more predefined criteria for the one or more metrics along which the machine learning model is being evaluated), model training service 117 can provide an indication to the machine learning model that the response was correct/accurate. As another example, in response to determining that a response to a question is non-ideal (e.g., the response is inaccurate or otherwise does not satisfy one or more predefined criteria for one or more dimensions), model training service 117 can provide an indication to the machine learning model that the response was not correct. The indication that the response was not correct may also include a correct answer (e.g., an ideal answer). Model training service 117 may obtain the ideal answer from the ground truth dataset as the answer corresponding to the question used to prompt the machine learning model. In some embodiments, model training service 117 provides feedback to the machine learning model based on user feedback. For example, model training service 117 can provide to a user a response received from the machine learning model, and model training service 117 may receive from the user feedback which model training service 117 can provide to the machine learning model in connection with the response.

In some embodiments, model implementation service 110 comprises model deployment service 119. Model implementation service 110 uses model deployment service 119 to deploy a machine learning model. For example, in response to determining that training/re-training the machine learning model is complete (e.g., that the performance of the machine learning model being trained/re-trained satisfies the one or more predefined criteria), model deployment service 119 can deploy the machine learning model. Deploying the machine learning model may include one or more of: (i) exposing the machine learning model to another system, process, or service, such as via an interface (e.g., an application programming interface (API)), (ii) storing the machine learning model to a dataset such as data store 120, and/or (iii) sending the machine learning model to another system or service associated with the use case for which the machine learning model is to be implemented.

According to various embodiments, model deployment service 119 monitors deployed machine learning models. For example, model deployment service 119 monitors the performance of the deployed machine learning models. In some embodiments, model implementation service 110 (e.g., model deployment service 119) implements continuous monitoring the performance of a deployed machine learning model (e.g., an LLM in production) by running scheduled evaluations (e.g., tests against the ground truth dataset or a subset thereof), such as by invoking evaluation service 115 to perform an evaluation of the deployed machine learning model. Model implementation service 110 (e.g., evaluation service 115 or model deployment service 119) generates detailed reports highlighting any deviations or drifts in the behavior or performance of the deployed machine learning model.

Administrator system 130 comprises an administrator system for use by an administrator. For example, administrator system 130 comprises a system for communication, data access, computation, etc. An administrator uses administrator system 130 to maintain and/or configure the performance or settings of model implementation service 110 and/or one or more of data stores (e.g., data store 120). For example, an administrator uses administrator system 130 to start and/or stop services on model implementation service 110 and/or data store 120, to reboot data store 120, to install software on model implementation service 110 and/or data store 120, to add, modify, and/or remove data on data store 120, etc. Administrator system 130 communicates with model implementation service 110 and/or data store 120 via a web-interface. For example, administrator system 130 communicates with model implementation service 110 and/or data store 120 via a web-browser installed on administrator system 130. As an example, administrator system 130 communicates with model implementation service 110 and/or data store 120 via an application running on administrator system 130.

In various embodiments, an administrator (or other user associated with a tenant or entity with which the tenant is associated such as a customer) uses administrator system 130 to configure a service provided to a tenant (e.g., an instantiation for an organization associated with a particular corpus, ground truth dataset, or machine learning model to be deployed). As an example, the administrator uses administrator system 130 to communicate with model implementation service 110 to configure the service provided to the tenant. For example, administrator system 130 may communicate with model implementation service 110 via a business application layer. The business application layer can serve as a gateway via which the administrator may interface to manage, configure, etc. a data layer, a control layer, and/or a business layer of model implementation service 110.

According to various embodiments, the administrator (e.g., an application developer or data model architect) uses administrator system 130 to configure (e.g., define) a use case or to set parameters of a dataset from which a ground truth dataset is to be determined or that is otherwise associated with a use case for which a machine learning model (e.g., a target LLM) is to be deployed. The administrator can also input configurations for the generation of the ground truth dataset, evaluation of the ground truth dataset, evaluation of a machine learning model being trained, evaluation of a deployed machine learning model, etc. As an example, the administrator may input parameters pertaining to one or more dimensions/metrics along which the machine learning models are to be evaluated. As another example, the administrator can select a dataset from which the ground truth dataset is to be determined, or otherwise upload a set of documents for the corpus. As another example, the administrator can select a second machine learning model to be used in connection with generating the ground truth dataset. Additionally, or alternatively, the administrator can use administrator system 130 to configure one or more policies for model implementation service 110, such as one or more security policies (e.g., an access permissions policy that defines user permissions for data stored in data store 120, such as permissions for accessing a particular model) and/or one or more compute resource policies, etc.

Data store 120 stores one or more datasets. In various embodiments, the one or more datasets comprise human resources data, talent data, performance data, financial data, organizational planning data, or any other appropriate data. In some embodiments, data store 120 stores one or more datasets for a plurality of tenants. In various embodiments, a tenant comprises an organization such as a company, a government entity, a sub-organization of an organization (e.g., a department), or any other appropriate organization. For example, data store 120 comprises one or more database systems for storing data in a table-based data structure, an object-based data structure, etc. In various embodiments, data store 120 comprises one or more of: a business database system, a human resources database system, a financial database system, a university database system, a medical database system, a manufacturing database system, or any other appropriate system. In some embodiments, data store 120 comprises one or more object-oriented database systems.

According to various embodiments, data store 120 stores a corpus dataset (e.g., a dataset from which a corpus for a tenant/organization/customer is determined) and one or more ground truth datasets. Data store 120 may additionally store results from evaluations performed with respect to ground truth datasets or machine learning models (e.g., target models being trained, or models that have been deployed such as in production).

According to various embodiments, a user uses system 100 (e.g., a client or terminal, such as client system 140, that connects to model implementation service 110 via network 150) to define business logic and/or to execute such business logic with respect to data (e.g., one or more datasets) stored on data store 120. As an example, a user inputs to client system 140 one or more requests (e.g., a user query) to model implementation service 110 for model implementation service 110 to train a machine learning model (e.g., for a particular use case). As another example, a user inputs to client system 140 one or more queries to be run against a dataset stored in data store 120. As another example, a user inputs to client system 140 one or more queries to be run against a deployed machine learning model (e.g., for the use case).

In some embodiments, the corpus obtaining service 111, ground truth service 113, evaluation service 115, model training service 117, and model deployment service 119, or any subset or combination thereof, can be implemented on a single server or a plurality of servers. For example, model deployment service 119 and ground truth service 113 are different modules running on the same server or set of servers.

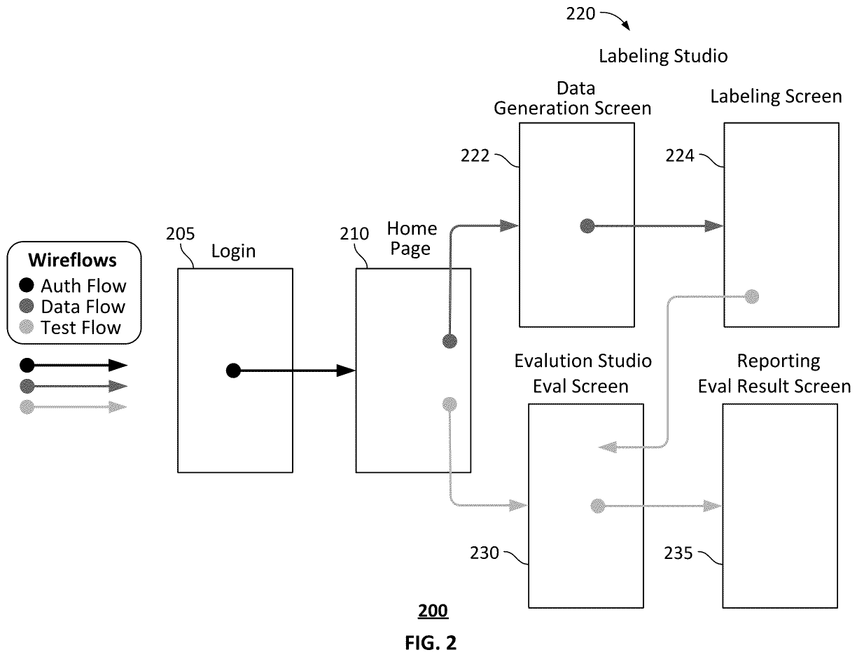

FIG. 2 is a block diagram of a user interface service for configuring a user interface for managing implementation of a model according to various embodiments. In some embodiments, user interface service 200 is implemented by system 100, such as by model implementation service 110.

According to various embodiments, the system comprises three primary modules designed for user interaction. User interface service 200 illustrates an example of a user's journey through the training and/or deployment of machine learning models, such as for particular use cases that can be defined by the user at least indirectly through the selection/curation of a corpus dataset with respect to which the machine learning model is to be trained. In the example shown, user interface service 200 configures a plurality of user interfaces in connection with enabling a user to request or manage the training and/or deployment of machine learning models. As an example, the plurality of user interfaces comprise a login interface 205, a home page interface 210, a data generation interface 222, a labelling interface 224, an evaluation interface 230, and an evaluation result interface 235. The data generation interface 222 and the labelling interface 224 may be configured by a subservice/module such as labelling studio 220.

Login interface 205 is configured to enable a user or other system or service to access the system. For example, the user or other system or service can be authenticated through login interface 205. In response to the user or other system or service being authenticated, user interface service 200 can configure home page interface 210. Home page interface 210 provides an interface via which the user can manage the training/re-training and/or deployment of machine learning models. For example, the user can use home page interface 210 to select to invoke a process to allow the user to define a use case (e.g., a use case dataset or a corpus dataset is selected) or to invoke a process for the user to configure/define settings associated with the ground truth service that determines (e.g., generates) a ground truth dataset. As an example, the user can select to configure (e.g., select) the second machine learning model (e.g., the ground truth model) to be used to generate the ground truth dataset. As a further example, the user can use home page interface 210 to select to invoke or configure an evaluation service for evaluating machine learning models (e.g., target LLMs to be deployed or already deployed machine learning models).

In response to determining that the user has selected to configure a use case for which a first machine learning model (e.g., the target LLM) is to be trained and deployed, user interface service 200 can invoke labelling studio 220. In connection with invoking labelling studio 220, user interface service 200 configures data generation interface 222. The user can use data generation interface 222 to define a use case dataset (e.g., a corpus dataset). For example, the user uses data generation interface 222 to provide a collection of documents (or select a location from which the document can be obtained), which are then utilized by the labelling studio 220 to generate ground truth data for a specific task. Labelling studio 220 can invoke a process or service (e.g., a ground truth service) for determining (e.g., generating) the ground truth dataset for the particular use case. The ground truth dataset for the particular use case can be generated based at least in part on one or more metrics, such as one or more usability metrics provided in Table 1. For example, the determined ground truth dataset can be evaluated based at least in part on one or more of the metrics. In some embodiments, the user can additionally use data generation interface 222 to configure or select a second machine learning model to be used to generate the ground truth dataset (e.g., to generate a set of questions and/or answers based on the use case dataset).

In response to the user providing (e.g., selecting or otherwise defining) the use case dataset, labelling studio 220 can invoke a service to generate the ground truth dataset. The user can use labelling interface 224 to provide labelling of the items generated for the ground truth dataset (e.g., the questions and/or answers). For example, an SME can use labelling interface 224 to provide feedback or otherwise configure the ground truth dataset.

According to various embodiments, a ground truth service is configured to enhance the productivity of SMEs in connection with deploying machine learning models for desired use cases. The ground truth service can enhance the productivity of the SMEs by automating the generation of potential questions and answers. This automation eliminates the need for SMEs to manually create these datasets, saving time and resources. The system (e.g., the ground truth service) can leverage various techniques to create a comprehensive set of questions that cover the entire corpus of documents provided by the client. Examples of techniques that can be implemented include text extraction, topic modeling, and graph-based question-answer generation, etc. In some embodiments, the generated questions and answers are then reviewed by SMEs to ensure their accuracy and relevance in an intuitive way, serving as the ground truth for further testing. The generated ground truth dataset can be used to improve the GenAI system, such as to fine tune the first machine learning model(s) being trained and/or deployed for the corresponding use case (e.g., the target LLM).

Upon the generation of the ground truth dataset or in response to the user selecting, via home page interface 210, to invoke or configure an evaluation service for evaluating machine learning models, user interface service 200 configures evaluation interface 230 to enable the user to evaluate one or more machine learning models, such as machine learning models being trained for the particular use case, or machine learning models already deployed for the use case. The user can use evaluation interface 230 to implement the established ground truth to evaluate the performance of the first machine learning model (e.g., the target LLM) in relation to the corresponding task. For example, the system implements an evaluation service to evaluate the machine learning model(s) along one or more metrics.

According to various embodiments, the system enables flexibility in evaluation frequency. Users can opt for manual evaluation, initiating evaluations as needed, or they can schedule recurring evaluations to run automatically at predetermined intervals (or in response to the satisfaction of predetermined criteria) within the system. The system can implement the evaluation service to provide ongoing monitoring and assessment of the performance for machine learning models, such as models deployed for the particular use case (e.g., GenAI models deployed for the use case).

In response to the one or more machine learning models being evaluated, user interface service 200 can configure evaluation result interface 235 to provide evaluation results (e.g., to cause a user interface to display one or more indications or representations associated with the evaluation results). The evaluation results generated from these evaluations can be systematically captured and stored within a reporting and monitoring service (e.g., model deployment service 119). The repository of evaluation results serves as a valuable resource for subsequent analysis, enabling users to gain insights into a particular machine learning model's behavior and performance over time.

According to various embodiments, the system implements a reporting service (or reporting module) that stores evaluation results over time. This allows users to track the machine learning model (e.g., the LLM) performance and identify any drifts or deviations from the expected behavior. Additionally or alternatively, the system can automatically analyze the evaluation results over time and determine performance characteristics, including any drifts or deviations in the behavior of the machine learning model, or drifts or changes in scope of the use case dataset (e.g., the corpus). The system can generate reports based on the evaluation results. These reports can provide valuable insights into the strengths and weaknesses of the machine learning model (e.g., the target LLM or a deployed machine learning model), and corrective actions to be performed can ensure the machine learning model remains compliant and effective. The corrective actions can be invoked by users or automatically by the system in response to the system determining that the evaluated machine learning model is insufficient along one or more metrics (e.g., the machine learning model is not behaving as expected for the use case).

According to various embodiments, an evaluation service is configured to enable the evaluation (e.g., testing) of GenAI systems, such as machine learning models (e.g., LLMs) deployed for use cases. The evaluation service can enable testing of the first machine learning model (e.g., the machine learning model being trained/re-trained for deployment in a corresponding use case) across one or more dimensions/metrics. In some embodiments, the evaluation service evaluates the machine learning model along a plurality of metrics. Examples of metrics (e.g., usability metrics) include, without limitation, accuracy, bias, toxicity, and hallucination. In some embodiments, the system automatically selects appropriate metrics for each dimension based on the specific use case and domain. For example, to measure accuracy, the system uses the overall similarity or word-by-word matching, for bias, hate and toxicity the system looks for specific words. The system (e.g., the evaluation service) can also allow for customization and refinement of metrics based on user feedback and ongoing evaluation. The ability of the system (e.g., the evaluation service) to test across multiple dimensions ensures that the machine learning model (e.g., the target LLM) responses are not only accurate but also safe, unbiased, and aligned with the desired behavior (e.g., as defined by one or more predefined criteria or thresholds).

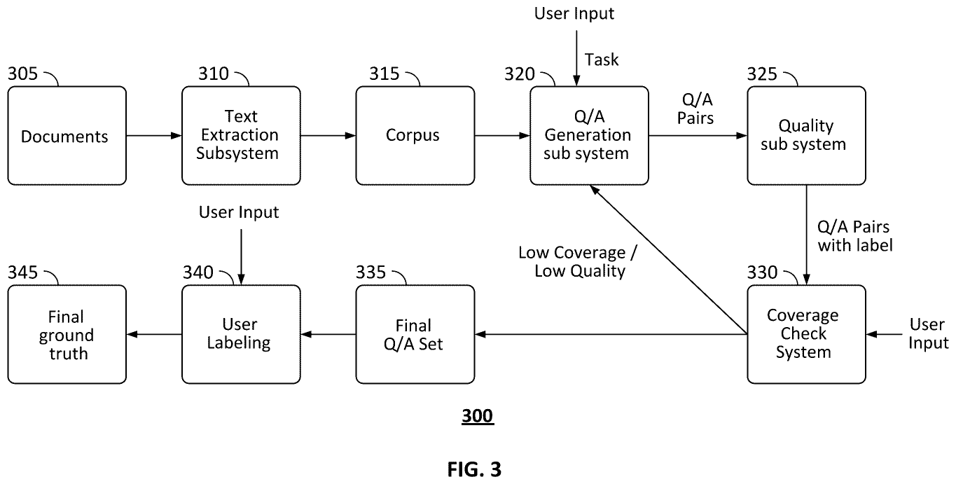

FIG. 3 is a block diagram of a ground truth generation service according to various embodiments of the present application. In some embodiments, ground truth generation service 300 implements at least part of system 100. For example, ground truth generation service 300 can implement ground truth service 113 of model implementation service 110 of FIG. 1. In some embodiments, ground truth generation service 300 implements at least part of one or more of processes 1300, 1500, 1700, 1800, and/or 2000 of FIGS. 13, 15, 17, 18, and 20.

In the example shown, ground truth generation service 300 implements one or more services (or submodules) in connection with performing a ground truth dataset generation process. Ground truth generation service 300 implements use case dataset service 305 to obtain a use case dataset. Use case dataset service 305 can receive files or documents manually uploaded from a user or other system or can retrieve or access files or documents identified by a user or other system, such as by pointing use case dataset service 305 to a location(s) at which the use case dataset is stored. The use case dataset can comprise a variety of files or documents that are representative of a particular use case, such as files or documents used or accumulated by an organization or a particular team or department, or for a particular task or set of tasks. In some embodiments, the use case dataset comprises a diverse collection of documents in various formats such as PDFs, word documents, presentations, diagrams, and images. This range of formats and types of files or documents mirrors the real-world situation, where information is often spread across different sources and mediums. These documents form the knowledge base from which a ground truth dataset is to be generated (e.g., from which ground truth generation service 300 is to extract question-and-answer pairs). These documents may be the same documents utilized by the target LLM (e.g., the first machine learning model being trained for deployment in the particular use case) when answering user queries (e.g., when the target LLM is deployed.

Ground truth generation service 300 implements an extraction service 310 that is configured to extract information from the use case dataset. For example, extraction service 310 can process the files or documents comprised in the use case dataset to extract text.

Ground truth generation service 300 implements a corpus determination service 315, which is configured to determine a corpus based at least in part on the use case dataset. For example, corpus determination service 315 determines a corpus for a particular use case based at least in part on the text extracted from the files or documents comprised in the use case dataset.

Ground truth generation service 300 implements a Q/A generation service 320 that is configured to generate a set of question and answer pairs based at least in part on the corpus. In some embodiments, Q/A generation service 320 obtains the set of question and answer pairs based at least in part on querying a second machine learning model to generate the questions and corresponding answers. The second machine learning model (e.g., an LLM) may be trained/configured using a larger (e.g., broader) knowledge base than the corpus to be used for training the first machine learning model (e.g., the target LLM). In some embodiments, Q/A generation service 320 generates the set of question and answer pairs based further on a user input that is obtained by Q/A generation service 320. As an example, the user input may define the task (e.g., a use case) for which a set of answers and questions is to be generated. In various embodiments, the user input comprises any of the tasks described in table 1 such as accuracy, hallucination, toxicity and bias.

In response to the obtaining the set of question and answer pairs (e.g., in response to the generation of the set of questions and answers for the ground truth dataset), ground truth generation service 300 can perform a quality analysis with respect to the question and answer pairs. Ground truth generation service 300 can implement a quality service 325 to perform the quality analysis. In some embodiments, the performing the quality analysis includes iteratively providing a question and answer pair to a user (e.g., an SME) to manually analyze and provide feedback. The user feedback can be used to label the question and answer pair. In some embodiments, the performing the quality analysis includes automatically labelling the question and answer pairs, such as programmatically based on an automatic analysis of the set of questions and answers.

In some embodiments, the question and answer pairs are analyzed and/or labeled across one or more dimensions. Examples of dimensions that can be implemented in the quality analysis of the question and answer pairs include: (i) grammatical correctness, (ii) relevance, (iii) factual accuracy, and (iv) complexity. Various other dimensions may be implemented for analyzing the quality of the question and answer pairs.

The generated question and answer pairs, along with their context, are passed to quality service 325, which can implement another fine-tuned model for a thorough evaluation of the question and answer pair quality and complexity. Quality service 325 can serves as a critical checkpoint in the ground truth dataset pipeline to ensure the reliability and effectiveness of the generated content to be used in the ground truth dataset. According to various embodiments, the quality analysis performed by quality service 325 comprises a classification task to label the generated Q/A pairs on one or more metrics, such as natural language processing (NLP) metrics like grammar, relevance, and complexity. Quality service 325 can implement various filters and checks to assess the quality of the generated questions and answers. These filters and checks cover a wide range of criteria, including checks or analysis across a variety of dimensions.

In some embodiments, quality service 325 evaluates the generated Q/A pairs for proper grammar, syntax, and punctuation. The grammar is checked based on rules, usually through the Context-Free Grammar (CFG). This ensures that the questions and answers are well-structured, easy to understand, and free from grammatical errors.

In some embodiments, quality service 325 assesses the relevance of the generated Q/A pairs to the provided context. The context is usually a subset of corpus or can be the whole corpus. Quality service 325 checks whether the questions and answers directly relate to and are supported by the information presented in the context (e.g., the subset of the corpus or the whole of the corpus). In some embodiments, this is done programmatically using any distance function to measure the similarity. This evaluation ensures that the Q/A pairs are meaningful and coherent within the context.

In some embodiments, quality service 325 verifies the factual accuracy of the generated Q/A pairs. Quality service 325 verifies whether the answers provided are consistent with established facts and knowledge using an external knowledge base. This evaluation aims to ensure that the Q/A pairs do not contain factually incorrect or misleading information.

In some embodiments, quality service 325 evaluates the complexity of the generated Q/A pairs. In some embodiments, the complexity is calculated programmatically using rule-based Context Free Grammar. Quality service 325 assesses whether the questions and answers demonstrate a depth of understanding and critical thinking. This evaluation ensures that the Q/A pairs are not overly simplistic or superficial but rather encourage deeper exploration and analysis of the provided context (e.g., the context defined by the boundaries of the corpus).

In some embodiments, quality service 325 analyzes the linguistic structure, semantic meaning, and relationships within the generated Q/A pairs. In some embodiments, the linguistic structure is accessed using CFG, the semantic meaning is accessed using either LLM or encoder/decoder models, and relationships are accessed using extracting the entities using LLM or any NLP models. Quality service 325 can also leverage external knowledge resources (e.g., knowledge resources exposed by third party services, or other predetermined knowledge resources that are generated at least partially independently of the use case dataset), such as knowledge graphs and databases, to verify factual accuracy and provide additional context.

The use of quality service 325 to analyze the quality of the Q/A pairs before inclusion in the ground truth dataset can significantly enhance the overall quality and reliability of the generated content. Quality service 325 can ensure that the generated Q/A pairs are grammatically correct, relevant to the context, factually accurate, and intellectually stimulating, promoting a deeper understanding of the subject matter.

In response to the set of questions and answers (e.g., the Q/A pairs) being analyzed for quality (e.g., labeled with respect to one or more quality metrics), ground truth generation service 300 can evaluate the coverage of the set of questions and answers, such as relative to the corpus. For example, ground truth generation service 300 implements a coverage check service 330 that analyzes the extent to which the set of questions and answers cover the context within (e.g., defined by) the boundaries of the corpus. In some embodiments, coverage check service 330 invokes quality evaluation service 600 of FIG. 6 to evaluate the extent to which the set of questions and answers cover the corpus (e.g., the context of the corpus). Coverage check service 330 can evaluate the scope of coverage provided by the set of questions and answers automatically (e.g., programmatically) or manually based on user input, or through a combination of programmatic analysis and user (e.g., SME) analysis.

According to various embodiments, coverage check service 330 determines whether the set of questions and answers sufficiently covers the corpus (e.g., the context defined by the corpus). As an example, the determination of whether the set of questions and answers sufficiently covers the corpus includes determining whether an extent to which the set of questions and answers covers the corpus exceeds a predefined coverage threshold. As another example, the determination of whether the set of questions and answers sufficiently covers the corpus includes determining that the set of questions and answers fully covers the corpus.

In response to determining that the set of questions and answers does not sufficiently cover the corpus and/or that the set of questions and answers does not satisfy a predefined quality criteria, ground truth generation service 300 causes Q/A generation service 320 to generate new or updated question and answer pairs Ground truth generation service 300 can iteratively cause Q/A pairs to be generated, perform a quality analysis with respect to the generated Q/A pairs, and evaluate the coverage of the set of questions and answers (or at least the subset of questions and answers deemed to satisfy a predefined quality criteria) relative to the corpus. Ground truth generation service 300 can perform the foregoing iteration until the corpus (e.g., the context defined by the corpus) is sufficiently covered by high quality Q/A pairs (e.g., a set of questions and answers satisfying a predefined quality criteria).

In response to determining that the corpus is sufficiently covered by high quality Q/A pairs, ground truth generation service 300 uses final Q/A service 335 to determine the final Q/A pairs to be used in the ground truth dataset. For example, final Q/A service 335 determines the set (or subset) of high-quality question and answer pairs that provide sufficient coverage of the corpus. As another example, final Q/A service 335 can discard low quality question and answer pairs, or question and answer pairs that provide coverage for context that is covered by one or more other question and answer pairs.

Ground truth generation service 300 then implements (e.g., invokes) user labelling service 340 to provide the final Q/A pairs to be used in the ground truth dataset to a user(s) for labelling. In various embodiments, a user labels the data by either upvoting or downvoting or assigning qualitative labels like good, neutral and bad. User labelling service 340 can configure a user interface(s) to display to the user the Q/A pairs and to receive a user input for the Q/A pairs.

Ground truth generation service 300 then implements final ground truth service 345, which is configured to obtain the labeled final Q/A pairs, store the labeled final Q/A pairs, and expose the final Q/A pairs as a ground truth dataset for the corpus. For example, final ground truth service 345 can expose (e.g., provide) the ground truth dataset to a service or pipeline that trains/configures a first machine learning model (e.g., a target LLM) for a use case associated with the corpus.

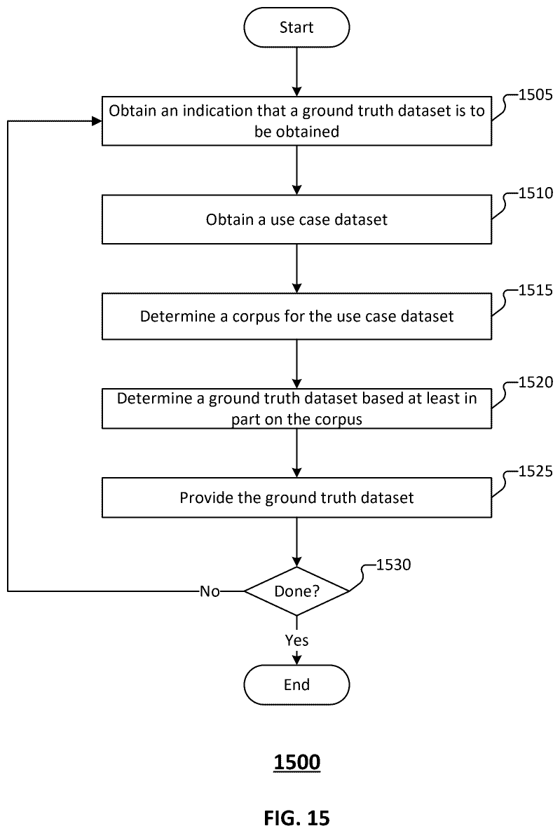

FIG. 4 is a block diagram of a corpus determination service according to various embodiments. In some embodiments, corpus service 400 implements at least part of system 100. For example, corpus service 400 can implement corpus obtaining service 111 of model implementation service 110 of FIG. 1. In some embodiments, corpus service 400 implements at least part of one or more of processes 1300, 1500, and/or 1600 of FIGS. 13, 15, and/or 16.

LLMs have demonstrated an impressive ability to comprehend and interpret natural language. To optimize/improve the performance of LLMs, it is important to provide the LLMs with a sufficient amount of clean text. According to various embodiments, corpus service 400 processes the files or inputs to extract the clean text.

According to various embodiments, processing input documents and files to extract text information is a fundamental step in constructing a high-fidelity corpus for training and configuring an LLM tailored to an organization's needs. The system begins by handling various types of input documents, which may include scanned images, Portable Document Format (PDF) documents, handwritten notes, or any files containing non-machine-readable text. The system can implement various techniques for extracting information (e.g., text information) from these input documents and/or files.

According to various embodiments, corpus service 400 can implement a document extraction service that is configured to identify and extract relevant text, tables, images, and other pertinent information from the input documents. As shown in FIG. 4, corpus service 400 is configured to elevate the quality of textual data extracted from diverse sources. Various embodiments use this refined data in connection with fueling machine learning models (e.g., LLMs) to configure the LLMs to perform optimally in understanding and generating human-like language.

Corpus service 400 comprises document obtaining service 405 that is configured to obtain/retrieve documents that serve to define the corpus. The documents can be manually uploaded by the user or the user can provide an indication of the location(s) at which document obtaining service 405 can obtain the documents. In various other embodiments, document obtaining service 405 can programmatically determine the set of documents to define the context (e.g., the use case dataset), such as by obtaining an indication of the task or use case and automatically determining the relevant documents.

In response to obtaining (e.g., determining) the use case dataset (e.g., the set of documents or files to be processed), corpus service 400 uses component identifier service 410 to discern various components within the documents/files comprised in the use case dataset. As an example, component identifier service 410 analyzes the documents/files and identifies various components, such as tables, figures, text, etc. The identification of the various components enables the corpus service 400 to differently (and appropriately) process the documents/files (or portions thereof) according to the component type. As an example, tables encapsulate structured information demanding special attention to retain its organization and significance during extraction. As another example, images may comprise text that is represented in an image and corpus service 400 can perform a text recognition (e.g., perform an optical character recognition (OCR) process) to identify/recognize text in the image(s) that can be extracted for use in determining/defining the corpus.

In response to identifying text within the documents/files, corpus service 400 extracts and refines the identified text. The refinement of the identified text may comprise removal of noise, formatting discrepancies, and/or extraneous information. Such cleaning/refining amplifies the signal-to-noise ratio, aiding the LLM in grasping the core message.

In some embodiments, corpus service 400 uses clean text service 415 to extract text from text-based documents (e.g., word documents, hypertext markup language (HTML) documents, emails, messages from instant messaging services such as Slack, or Microsoft Teams, etc.).

For documents comprising tables and structured data, the system uses specialized extraction techniques. In some embodiments, corpus service 400 uses table extraction service 420 to extract information from tables identified in the documents/files. Table extraction service 420 can implement various table extraction algorithms to identify table boundaries, rows, columns, and cells within the document. The table extraction algorithms extract not only the textual content but also preserve the structural relationships between data points. Table extraction service 420 extracts the identified tables in a manner that table extraction service 420 obtains the data comprised in the table and the associated metadata, such as the associated labels (column/row headers). This ensures that numerical data, headings, and associated labels are accurately captured and represented in the corpus. The system (e.g., table extraction service 420) may also process embedded charts or graphs by extracting any accompanying textual descriptions or legends to provide context. This meticulous table extraction ensures that the tabular data's structure and meaning remain intact, contributing valuable context to the LLM.

In some embodiments, corpus service 400 uses text recognition service 425 to process documents/files where text is comprised in an image or not readily extractable (e.g., machine-readable) from the document. Text recognition service 425 can implement an OCR process to process images, scanned documents, or the like. OCR algorithms analyze the visual patterns in images to recognize and convert characters into machine-encoded text. Advanced OCR systems can handle diverse fonts, layouts, and languages, and are capable of processing complex documents such as forms, diagrams, and multi-column texts. Text recognition service 425 deciphers the visual representation of text, transforming it into a machine-readable format, thus expanding the pool of accessible textual data.

Once the text is extracted from all input documents, the system proceeds to construct the corpus by analyzing and enriching this raw text data. In some embodiments, corpus service 400 comprises document corpus determination service 430 that is configured to determine the corpus (e.g., the corpus for a particular use case or task). Corpus determination service 430 obtains the information (e.g., extracted text) extracted from the use case dataset (e.g., a set of documents, files, etc.) and processes the information to determine the corpus. Corpus determination service 430 can implement various techniques for processing the information. Examples of some techniques that may be implemented are described below.

In some embodiments, corpus determination service 430 implements Named Entity Recognition (NER) techniques to identify and categorize entities within the extracted text, such as names of individuals, organizations, locations, dates, and domain-specific terms. NER helps in structuring the text and making it more informative by tagging entities that are significant to the organization's domain. This adds a layer of semantic understanding, enabling the LLM to grasp the nuances of the information

In some embodiments, corpus determination service 430 implements relation extraction. This technique uncovers intricate connections and dependencies within the text, fostering a deeper comprehension of the content. The implementing the relation extraction involves detecting and classifying semantic relationships between the recognized entities. For example, in a sentence like “Dr. Smith joined the Research Department in 2019,” the system identifies “Dr. Smith” as a person entity and “Research Department” as an organization entity, with the relationship “joined” linking them and “in 2019” providing a temporal context. This relational information enhances the corpus by adding layers of meaning and facilitating deeper understanding.

In some embodiment, the system additionally or alternatively applies additional NLP techniques to achieve a high-fidelity corpus. Part-of-speech tagging assigns grammatical categories to each word (such as noun, verb, adjective), which aids in syntactic parsing and understanding sentence structures. Dependency parsing goes a step further by analyzing the grammatical dependencies between words, helping the system comprehend complex sentences and hierarchical relationships within the text.

In some embodiment, the system additionally or alternatively applies topic modeling algorithms such as Latent Dirichlet Allocation (LDA) which are used to discover hidden thematic structures in the corpus. By identifying clusters of words that frequently occur together, the system uncovers underlying topics and themes present in the documents. This helps in organizing the corpus thematically and ensures that the LLM is exposed to all relevant subject areas.

According to various embodiments, corpus service 400 (e.g., corpus determination service 430) conducts data cleaning and normalization processes to enhance the quality and reliability of the corpus. This involves correcting errors from the OCR process, such as misrecognized characters or words, and standardizing formats for dates, numbers, and units of measurement. The system may also remove irrelevant content like boilerplate text, disclaimers, or duplicates to focus on meaningful information.

In some embodiment, the system additionally or alternatively applies semantic analysis techniques to understand the meaning and context of words and phrases within the text. Word sense disambiguation helps the system determine the correct meaning of a word based on context when multiple meanings are possible. Coreference resolution is used to identify when different words or phrases refer to the same entity, which is essential for maintaining consistency and understanding across the corpus.

In some embodiment, the system (e.g., corpus determination service 430) additionally or alternatively applies techniques to construct a knowledge graph using the extracted entities and relationships. In this graph, entities are represented as nodes, and relationships are represented as edges connecting these nodes. The knowledge graph provides a structured and interconnected representation of the organization's knowledge, which the LLM (e.g., the second machine learning model) can leverage to improve its understanding and generate more accurate responses.

The system (e.g., corpus determination service 430) can incorporate domain-specific ontologies and taxonomies to further enrich the corpus. By mapping extracted entities and concepts to these predefined structures, the system ensures that the corpus aligns with industry standards and organizational knowledge frameworks. This enhances the relevance and applicability of the information used by the second machine learning model to determine a ground truth dataset that can be used to train the target LLM (e.g., the first machine learning model).

In some embodiments, corpus service 400 (e.g., corpus determination service 430) may additionally employ sentiment analysis to determine the emotional tone or polarity of the text, which can be valuable for certain applications like customer feedback analysis. It can also use summarization techniques to generate concise representations of lengthy documents, capturing the essential information without extraneous details.

In some embodiments, in cases where the corpus includes multilingual content, the system (e.g., corpus determination service 430) may additionally utilize language detection and translation services to process and normalize text in different languages. This ensures that the LLM is capable of understanding and generating responses across the linguistic spectrum present in the organization's documents.

By integrating these types of techniques, corpus service 400 analyzes the extracted text information thoroughly to obtain a high-fidelity corpus. This comprehensive approach ensures that the LLM is trained on accurate, relevant, and context-rich data, which is crucial for generating insights that are aligned with the organization's knowledge base and operational requirements. The resulting corpus not only covers the breadth of information present in the original documents but also enhances it by providing structured, meaningful, and high-quality data for the second machine learning model to analyze and determine a ground truth dataset that can be used to train the target LLM (e.g., the first machine learning model).

In scenarios where the extracted text is voluminous, corpus service 400 (e.g., corpus determination service 430) may additionally implement summarization techniques to condense the information while preserving the essence. This helps streamline the data presented to the second machine learning model (e.g., the LLM), potentially improving its efficiency.

FIG. 5 is a block diagram of a question and answer generation service according to various embodiments. In some embodiments, Q/A generation service 500 implements at least part of system 100. For example, Q/A generation service 500 can implement at least part of ground truth service 113 of model implementation service 110. In some embodiments, Q/A generation service 500 implements at least part of one or more of processes 1300, 1500, 1700, 1800, and/or 2000 of FIGS. 13, 15, 17, 18, and 20.

According to various embodiments, in response to determining a corpus, the system determines a ground truth dataset to be used in connection with configuring (e.g., training or retraining, etc.) the first machine learning model (e.g., the target LLM). As an example, the system can invoke a Q/A generation service 500 to generate the ground truth dataset for configuring a large language model (LLM) customized to an organization's specific corpus. In some embodiments, the method or technique for generating the ground truth dataset comprises the creation of a graph that represents the entities and concepts within the corpus, serving as a foundational structure for generating relevant question-and-answer (Q/A) pairs.

In response to obtaining the corpus (e.g., a use case-specific or task-specific corpus), the system can perform an in-depth analysis of the corpus, which may encompass documents like reports, emails, policies, manuals, and other proprietary materials, or text information extracted from such documents. The system can implement advanced NLP techniques to extract key entities and concepts from the text. Entities may refer to specific items such as names of people, organizations, products, locations, or technical terms unique to the organization's domain, while concepts are broader topics or themes that encapsulate the main subjects discussed in the corpus. The system may utilize machine learning models specialized in entity recognition and topic modeling for this extraction. As an example, the system may implement NER models to identify and categorize entities within the text, while topic modeling algorithms like Latent Dirichlet Allocation (LDA) or clustering techniques group related terms to uncover underlying concepts.

Once the entities and concepts are extracted, the system uses the entities and/or concepts to construct a graph representing the corpus's knowledge structure. In this graph, nodes represent the identified entities and concepts, and edges represent the relationships between these nodes, indicating how they are connected within the context of the corpus. Relationships can be defined based on various criteria such as co-occurrence in documents, semantic similarity, or explicit connections mentioned in the text. For example, if a policy document states that “Department X is responsible for Compliance Y,” nodes representing “Department X” and “Compliance Y” would be connected. The graph effectively visualizes the corpus's content, highlighting the interconnectedness of different entities and concepts. This representation enables the system to more deeply understand the corpus's structure and facilitates the system's identification of key areas of knowledge.

With the graph constructed, the system and/or method proceeds to generate the ground truth dataset by querying a second machine learning model designed to produce meaningful and relevant question-and-answer pairs based on the graph and the original corpus. The second machine learning model may scan the graph to identify nodes and relationships that can serve as the basis for potential questions, focusing on significant entities and concepts, especially those with multiple connections indicating their importance within the corpus. For each identified node or relationship, the second machine learning model can formulate questions intended to elicit detailed information about the entity or concept. For instance, if the node represents “Product Z,” questions might include “What are the features of Product Z?” or “How does Product Z integrate with existing systems?” The model then searches the corpus to find accurate and comprehensive answers to these questions, using information retrieval techniques to locate relevant passages and extract the necessary details. The generated question-and-answer pairs are verified for accuracy and completeness, which may involve cross-referencing multiple documents within the corpus to ensure the answers are well-supported and accurately reflect the organization's knowledge.

The initial set of question-and-answer pairs forms the basis of the ground truth dataset. To ensure that the dataset is both comprehensive and aligned with the organization's standards, the system implements a rigorous evaluation process with respect to the Q/A pairs to be evaluated for inclusion in the ground truth dataset. For example, the system reviews the ground truth dataset (or at least those subsets of Q/A pairs that are deemed to be high quality or otherwise satisfy one or more quality thresholds or criteria) to determine if it sufficiently covers all significant entities and concepts represented in the graph, ensuring that the first machine learning model (e.g., the target LLM) will be trained on a wide range of topics relevant to the organization's operations. According to various embodiments, each question-and-answer pair is assessed to ensure it adheres to predefined boundaries related to content scope, bias, toxicity, hallucination tendencies, and legal or regulatory compliance. Any Q/A pairs that fall outside these boundaries are revised or removed. Based on this assessment, the ground truth dataset is updated iteratively, which may involve generating additional Q/A pairs for underrepresented areas in the graph or refining existing pairs to better align with the boundaries.

According to various embodiments, the system uses the refined ground truth dataset to configure (e.g., train) the first machine learning model (e.g., the target LLM) to understand and generate responses that accurately reflect the corpus content. The training process involves supervised learning, where the first machine learning model learns directly from the question-and-answer pairs, adjusting its parameters to improve its ability to generate similar responses. The first machine learning model may be further fine-tuned using reinforcement learning techniques that employ feedback mechanisms to reward correct adherence to the boundaries and penalize deviations.

According to various embodiments, as the organization's corpus evolves through the addition of new documents or changes in existing ones, the graph and consequently the ground truth dataset are updated. New entities and concepts are extracted from the updated corpus, and the graph is modified to include these additions, ensuring it remains an accurate representation of the current corpus. The second machine learning model can be re-engaged to generate new question-and-answer pairs based on the updated graph, keeping the ground truth dataset aligned with the latest information. The first machine learning model (e.g., a deployed machine learning model) is then retrained or reconfigured using the updated ground truth dataset to incorporate the new knowledge and maintain its effectiveness.

Returning to the example shown in FIG. 5, Q/A generation service 500 comprises corpus service 505, which is configured to obtain a corpus for which a ground truth dataset is to be determined. As an example, corpus service 505 can obtain the corpus determined by corpus service 400 of FIG. 4. Q/A generation service 500 generates potential questions and their corresponding answers (e.g., Q/A pairs) based on the information in the corpus (e.g., the context).

In some embodiments, Q/A generation service 500 may initially process/analyze the corpus to generate questions and answers. The system may subsequently receive feedback or inputs from a user(s) (e.g., SMEs) to customize the system's subsequent corpus analyses (e.g., subsequent iterations or refinements of Q/A pairs) to focus on specific areas of the corpus where the Q/A dataset to be used to obtain the ground truth dataset needs improved metrics. This technique enables users (or organizations for which the first machine learning model is to be deployed) to fine-tune the system's performance and get better results for their specific use case. As an illustrative example, if the system is used to generate questions and answers for a medical research project, a user (or organization) might want to focus the subsequent iterations of Q/A pair generation on the sections of the corpus that pertain to medical terminology and concepts. This would help to improve the accuracy of the system's output for the specific tasks pertaining to the medical research project.

An example workflow for performing iterations of Q/A pair generation includes: (i) after the initial run of the system, the system provides the results (e.g., the generated Q/A pairs) to a user (e.g., an SME) to review and identify the areas where the target LLM system is behaving poorly and/or areas where the initially generated Q/A pairs are deficient in relation to generating a ground truth dataset providing sufficient coverage of the corpus, (ii) the system receives a user selection of specific topics or areas of the corpus that the user wants subsequent iterations to focus on, and (iii) the system executes an iteration of the Q/A pair generation based at least in part on the user selection, such as to focus on the selected areas and produce improved results (e.g., Q/A pairs) for those specific topics.

Q/A generation service 500 may implement various techniques (or any combination thereof) to generate Q/A pairs. Example techniques that may be implemented include (a) a rule-based Q/A generation mechanism, (b) a sequence-to-sequence-based Q/A generation mechanism, (c) a complex/task-based Q/A generation mechanism, and (d) an LLM-based Q/A generation mechanism. In some embodiments, one or more of the complex/task-based Q/A generation mechanism, the rule-based Q/A generation mechanism, and the LLM-based Q/A generation mechanism are based at least in part on a graph generated based at least in part on the corpus. The graph can serve as a dynamic and comprehensive representation of the corpus, facilitating the generation of relevant and compliant question and

answer pairs. The use of the graph in connection with generating Q/A pairs for inclusion in the ground dataset not only enhances the performance of the first machine learning model (e.g., the target LLM trained based on the Q/A pairs using the graph) but also ensures its outputs remain aligned with the organization's evolving needs and regulatory obligations.

In some embodiments, the graph representing the corpus is generated through a combination of NLP techniques and graph theory principles/techniques. Entities and concepts are extracted using NER and topic modeling as previously described. Relationships between entities and concepts are identified by analyzing textual proximity, syntactic dependencies, and semantic similarity. Textual proximity considers entities mentioned together frequently as likely related. Syntactic dependencies analyze grammatical structures in sentences to indicate relationships, such as subject-object relationships. Semantic similarity connects concepts with similar meanings or contexts. Nodes and edges are created based on the extracted entities, concepts, and relationships. The graph may be directed or undirected, depending on whether the relationships have a directional nature, and edges may have weights indicating the strength of the relationship, such as the frequency of co-occurrence. Techniques like graph pruning may be applied to remove insignificant nodes or edges, simplifying the graph without losing essential information. Visualization of the graph aids in understanding the corpus's structure and identifying key hubs or clusters of related information.

Using the graph offers several benefits. It ensures enhanced coverage by considering all significant entities and concepts during the generation of the ground truth dataset. By understanding how entities and concepts are interconnected, the second machine learning model (e.g., an LLM) can generate more coherent and contextually relevant responses, demonstrating relationship awareness. The graph-based approach allows for easy updates as the corpus changes, ensuring the LLM remains current and adaptable. Additionally, the graph can help identify areas where boundary issues might arise, such as sensitive topics, allowing for proactive management and boundary enforcement.

According to various embodiments, Q/A generation service 500 comprises complex/task-based Q/A generation service 510. In response to obtaining the corpus, Q/A generation service 500 can use complex/task-based Q/A generation service 510 to generate complex or task-based Q/A pairs. In some embodiments, the graph-based generation is both local and global (e.g., a merged graph), the system can generate questions based on the extracted graph alone, plus the system can combine these generated questions with external graph and ask the question in more general way.

Q/A generation service 500 comprises graph extraction service 515. Graph extraction service 515 constructs a graph representing relationships and dependencies between entities and concepts mentioned in the text. The graph can enable the system (e.g., the second machine learning model that generates Q/A pairs based on the graph) to understand the context and meaning of words and phrases within a document. By creating a graph, the system can map out the connections between different pieces of information, allowing the system to gain a deeper understanding of the overall content.

In some embodiments, graph extraction service 515 constructs the graph in a manner according to which the graph is usable for LLMs with a lot of context. Traditional graph representations often use bare bone relationship labels, such as “is_a” or “part_of,” which provide limited information about the nature of the relationship. However, for LLMs to truly understand and reason about the text, the LLMs need more detailed and nuanced information about the relationships between entities and concepts. To address this need, the system (e.g., graph extraction service 515) augments the graph with rich semantic metadata that captures the specific nature of each relationship. For example, instead of simply labeling a relationship as “is_a,” the system may specify that a particular entity is a “type of” or a “subordinate of” another entity. This additional information provides LLMs with a more comprehensive understanding of the hierarchical structure and context of the text. By constructing the graph in this way, the system enables LLMs to leverage a wealth of contextual information when generating text or performing other language-related tasks. This technique allows LLMs to produce more coherent, informative, and contextually relevant output because the LLMS will have a better understanding of the relationships between different pieces of information within the text.

In some embodiments, Q/A generation service 500 can generate a broad knowledge base graph representing a knowledge base representing both the information comprised in the corpus as well as information outside the scope/boundaries of the corpus. This broad knowledge base graph can be used in connection with rule-based Q/A pair generation and LLM-based Q/A pair generation. In the example shown, Q/A generation service 500 comprises graph merging service 520. Graph merging service 520 obtains (e.g., from graph extraction service 515) the graph extracted based on the corpus and a global graph configured with a broader knowledge base than the corpus. In response to obtaining these graphs, graph merging service 520 merges the graph extracted based on the corpus and the global graph to configure a broad knowledge base graph.

In the example shown, Q/A generation service 500 comprises rule-based Q/A generation service 525. Q/A generation service 500 uses rule-based Q/A generation service 525 to apply a set of predefined rules to generate one or more Q/A pairs based on the corpus and/or the broad knowledge base graph (e.g., the merged graph obtained by graph merging service 520). Rule-based Q/A generation service 525 leverages carefully crafted rules and patterns to identify potential questions and their corresponding answers directly from the corpus. In some embodiments, the rules are based on the CFG's and the questions are generated programmatically using the CFG's. By analyzing the textual structure and content, rule-based Q/A generation service 525 can extract factual information, definitions, and other relevant details based on predefined linguistic cues.

In the example shown, Q/A generation service 500 comprises Seq2Seq Q/A generation service 530. Q/A generation service 500 uses Seq2Seq Q/A generation service 530 to apply one or more sequence-to-sequence models (Seq2Seq) to determine one or more Q/A pairs based on the corpus, thereby enhancing the ground truth dataset used to train the first machine learning model (e.g., the target LLM). The Seq2Seq models are a type of neural network that learns to map input sequences (context from the corpus) to output sequences (questions and answers). Seq2Seq models are particularly effective in tasks like machine translation, text summarization, and question generation because they can learn the mapping between input and output sequences of varying lengths.

Seq2Seq Q/A generation service 530 obtains a statement or a piece of information from the corpus and generates a corresponding question that could be answered by that statement. The original statement then serves as the answer to the generated question. For example, consider a sentence from the corpus: “The capital of France is Paris.” The Seq2Seq model would take this sentence as input and generate the question: “What is the capital of France?” The answer would be “Paris.” This process transforms declarative knowledge from the corpus into an interrogative format paired with accurate answers, enriching the ground truth dataset.

According to various embodiments, Seq2Seq Q/A generation service 530 can implement various Seq2Seq models to perform this task effectively. Examples of types of Seq2Seq models that may be implemented include transformer-based models, Recurrent Neural Network (RNN) based models, Pointer-Generator Networks, etc. The Seq2Seq model can be trained in two phases: (a) initially, it undergoes general training on large, publicly available datasets containing question-answer pairs to learn the fundamental patterns of question formation, and (b) subsequently, the model is fine-tuned on the organization's specific corpus to adapt to the domain-specific language, style, and content. In some embodiments, this fine-tuning process involves feeding the model with input passages from the corpus and training it to generate corresponding questions.

Seq2Seq Q/A generation service 530 can implement a transformer-based models that leverage the transformer architecture, which relies on self-attention mechanisms to capture relationships within the data without the need for sequential processing inherent in recurrent neural networks. Examples include T5 (Text-to-Text Transfer Transformer), developed by Google, which is a versatile model that treats every NLP problem as a text-to-text task and can be fine-tuned for question generation by training it on datasets where the input is a passage from the corpus and the output is a corresponding question. Another example is Bidirectional and Auto-Regressive Transformers (BART), created by Facebook AI, which combines the bidirectional encoding of Bidirectional Encoder Representations from Transformers (BERT) and the autoregressive decoding of generative pre-trained transformer (GPT). BART is particularly effective for generative tasks like question generation because it can reconstruct corrupted text sequences, making it adept at understanding and reformulating input text into questions.

Seq2Seq Q/A generation service 530 can implement an RNN-based model, such as by implementing traditional Seq2Seq architectures with encoder-decoder frameworks. Long Short-Term Memory (LSTM) networks can be used to address the vanishing gradient problem in standard RNNs, enabling the model to learn long-range dependencies. In question generation, an LSTM encoder processes the input sentence to create a context vector, which the decoder then uses to generate the question. (Gated Recurrent Unit (GRU) networks are similar to LSTMs but have a simplified architecture. GRU networks can be used in Seq2Seq models for tasks requiring less computational complexity while still capturing necessary dependencies.

Seq2Seq models with attention mechanisms allow the model to focus on specific parts of the input sequence when generating each word in the output sequence. Incorporating attention enables the model to align input tokens with output tokens effectively, which is crucial in question generation where certain keywords or phrases need to be transformed or highlighted in the question.

Seq2Seq Q/A generation service 530 can implement Pointer-Generator Networks, which can combine standard Seq2Seq generation with the ability to copy words directly from the input text. This is particularly useful when the question requires specific terminology or named entities present in the input, ensuring that the generated questions are accurate and contextually relevant.

In the example shown, Q/A generation service 500 comprises LLM-based Q/A generation service 535. Q/A generation service 500 uses LLM-based Q/A generation service 535 to apply one or more LLMs to generate Q/A pairs based at least in part on the corpus. For example, LLM-based Q/A generation service 535 queries the one or more LLMs for Q/A pairs. LLM-based Q/A generation service 535 may implement pre-trained language models fine-tuned for question generation, such as GPT-2 and GPT-3 (Generative Pre-trained Transformers), to generate Q/A pairs for inclusion in the ground truth dataset. Although these pre-trained models are primarily designed for text generation tasks, they can be fine-tuned on question-answering datasets to generate questions based on input passages. Their extensive pre-training on large corpora enables them to generate coherent and contextually appropriate questions. In some embodiments, the system can use LLMs to generate questions based on both the corpus of text that they have been trained on and the graph structure of the data.

The LLMs can be used to generate simple Q/A pairs and complex Q/A pairs. An example of a simple Q/A pair includes a question: “what is the capital of France?”; with corresponding answer: “Paris.” This is a simple question that can be easily answered by an LLM by searching the corpus for information about France. An example of a complex Q/A pair includes a question: “what is the relationship between the concept of “love” and the concept of “happiness” ?”; and corresponding answer: (a) love and happiness are often closely related, as love can be a source of great happiness, (b) however, love can also be complicated and sometimes painful, and it is not always associated with happiness, and (c) ultimately, the relationship between love and happiness is complex and multifaceted, and it depends on a variety of factors. This is a more complex question that requires the LLM to use its understanding of the graph structure of the data to identify the relationships between the concepts of “love” and “happiness.” The LLM then uses this information to generate an answer that is more nuanced and informative than a simple yes or no answer.

LLMs can be used to generate questions and answers on a wide range of topics, from simple factual questions to more complex and abstract questions. This makes them a valuable tool for education, research, and entertainment.

In the example shown, Q/A generation service 500 comprises Q/A aggregation service 540. Q/A generation service 500 uses Q/A aggregation service 540 to aggregate Q/A pairs obtained from the various techniques implemented to generate Q/A pairs. Using the illustrated example, Q/A aggregation service 540 aggregates: (a) Q/A pairs obtained from the rule-based Q/A generation service 525, (b) Q/A pairs obtained from the Seq2Seq Q/A generation service 530, and (c) Q/A pairs obtained from the LLM-based Q/A generation service 535.

Q/A generation service 500 comprises topic/aspect model tagging service 545. Q/A generation service 500 uses topic/aspect model tagging service 545 to obtain the set of aggregated Q/A pairs and tags the respective Q/A pairs for topics and aspects to enable grouping by topics and subtopics. This facilitates the presentation of information to users in a structured and organized manner. Each Q/A pair is associated with one or more topics, and each topic can be further divided into subtopics. In some embodiments, the topic modeling is done through various methods including latent Dirichlet allocation (LDA) and BERTopic (e.g., a topic modeling technique that leverages BERT (bidirectional encoder representations from transformers)). This tagging mechanism allows users to easily navigate through the content and quickly locate the information they are seeking. Additionally, the tagging enables advanced search and filtering capabilities, allowing users to refine their search results based on specific topics or subtopics. This enhances the overall user experience by providing a more efficient and personalized way to access and interact with the question-answer content.

In response to the Q/A pairs being processed by topic/aspect model tagging service 545, Q/A generation service 500 uses final Q/A determination service 550 to obtain the final set of Q/A pairs that can be used to determine a ground truth dataset. For example, the system may implement a quality analysis/evaluation of the final set of Q/A pairs to ensure that the Q/A pairs are high quality and provide sufficient coverage of the corpus. The generated question-and-answer pairs may be subjected to evaluation to ensure quality and relevance. The system can use automated metrics like Bilingual Evaluation Understudy (BLEU) scores to assess the linguistic quality of the generated questions by comparing them to reference questions. Additionally, human evaluation may be employed, where subject matter experts review the questions for accuracy, clarity, and alignment with the organization's standards.

According to various embodiments, the initial set of Q/A pairs form the basis of the ground truth dataset. To ensure that the ground truth dataset is both comprehensive and aligned with the organization's standards, it undergoes a rigorous evaluation process. The ground truth dataset is reviewed to determine if it sufficiently covers all significant entities and concepts of the corpus (e.g., represented in the graph), ensuring that the first machine learning model (e.g., the target LLM) will be trained on a wide range of topics relevant to the organization's operations. In some embodiments, each question-and-answer pair (or at least a subset of the final set of Q/A pairs obtained by Q/A generation service 500) is assessed to ensure it adheres to predefined boundaries related to one or more metrics, such as content scope, bias, toxicity, hallucination tendencies, and legal or regulatory compliance. Any Q/A pairs that fall outside these boundaries are revised or removed. Based on this assessment, the ground truth dataset is updated iteratively, which may involve generating additional question-and-answer pairs for underrepresented areas in the graph or refining existing pairs to better align with the boundaries.

With the refined ground truth dataset, the system trains (or configures) the first machine learning model (e.g., the target LLM) to understand and generate responses that accurately reflect the corpus content. The training process may involve supervised learning, where the first machine learning model learns directly from the question-and-answer pairs, adjusting its parameters to improve its ability to generate similar responses. The first machine learning model may be further fine-tuned using reinforcement learning techniques that employ feedback mechanisms to reward correct adherence to the boundaries and penalize deviations.

In some embodiments, the system implements a quality evaluation service that evaluates the quality of the ground truth dataset (or final set of Q/A pairs). As an example, the system passes the generated question/answer (Q/A) pairs, along with their context (e.g., the system passes the labeled Q/A pairs obtained by final Q/A determination service 550), to another fine-tuned model for a thorough evaluation of their quality and complexity. This evaluation mechanism can serve as a critical checkpoint to ensure the reliability and effectiveness of the generated content.

According to various embodiments, the quality evaluation service implements a classification task to label the generated Q/A pairs on NLP metrics like grammar, relevance, and complexity, etc. The quality evaluation service can implement various filters and checks that are employed to assess the quality of the generated questions and answers. These filters and checks cover a wide range of criteria, including one or more of: grammatical correctness, relevance, factual accuracy, complexity, etc.

In some embodiments, the quality evaluation service evaluates the generated Q/A pairs for proper grammar, syntax, and punctuation. This ensures that the questions and answers are well-structured, easy to understand, and free from grammatical errors.

In some embodiments, the quality evaluation service evaluates the relevance of the generated Q/A pairs to the provided context. The quality evaluation service checks whether the questions and answers directly relate to and are supported by the information presented in the context. This evaluation ensures that the Q/A pairs are meaningful and coherent within the context.

In some embodiments, the quality evaluation service evaluates or verifies the factual accuracy of the generated Q/A pairs. The quality evaluation service checks whether the answers provided are consistent with established facts and knowledge. This evaluation aims to ensure that the Q/A pairs do not contain factually incorrect or misleading information.

In some embodiments, the quality evaluation service evaluates the complexity of the generated Q/A pairs. The quality evaluation service assesses whether the questions and answers demonstrate a depth of understanding and critical thinking. This evaluation ensures that the Q/A pairs are not overly simplistic or superficial but rather encourage deeper exploration and analysis of the provided context.

In some embodiments, the quality evaluation service evaluates the linguistic structure, semantic meaning, and relationships within the generated Q/A pairs. The quality evaluation service can also leverage external knowledge resources, such as knowledge graphs and databases, to verify factual accuracy and provide additional context.

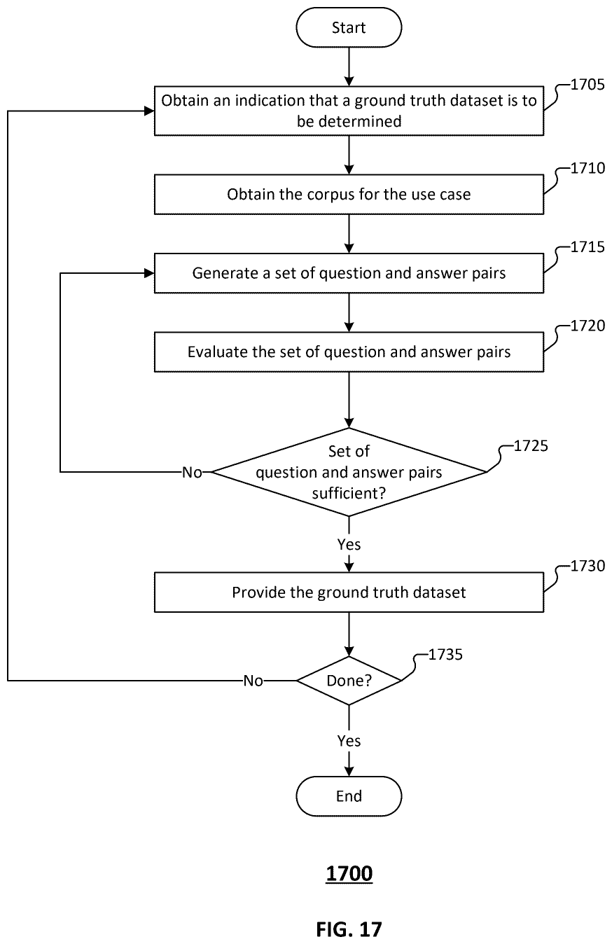

FIG. 6 is a block diagram of a ground truth quality evaluation service according to various embodiments. In some embodiments, quality evaluation service 600 implements at least part of system 100. For example, quality evaluation service 600 can implement at least part of evaluation service 115 of model implementation service 110. In some embodiments, quality evaluation service 600 implements at least part of one or more of processes 1300 and/or 1700 of FIGS. 13 and 17.

According to various embodiments, quality evaluation service 600 evaluates the quality and relevance of answers generated in response to questions, likely within a question-answering system that relies on a corpus of information.

At 605, quality evaluation service 600 obtains the Q/A pairs generated for the ground truth dataset, such as the final set of Q/A pairs obtained by final Q/A determination service 550. According to various embodiments, the system evaluates each Q/A pair (or a subset of the final set of Q/A pairs) along at least two dimensions: context and quality. The context dimension may refer to how well the answer aligns with the context provided in the question or any additional context given to the system. The quality dimension may encompass various factors contributing to a good answer, such as accuracy, completeness, clarity, and relevance.

The system may evaluate linguistic quality by checking for grammatical correctness, clarity, and coherence, ensuring that questions are well-formed, and answers are accurate and relevant. Quality evaluation service 600 may provide the Q/A pairs to users (e.g., SMEs) to review the pairs to ensure the Q/A pairs align with organizational standards. The system may additionally implement automated tools to detect issues like grammatical errors, factual inaccuracies, or biases.

At 610, quality evaluation service 600 determines a coverage of the Q/A pairs. In some embodiments, the system calculates coverage or overlap, such as using one or more distance metrics. Evaluating the coverage of the ground truth dataset (e.g., the generated question-and-answer pairs) enables the system to ensure that the first machine learning model is effectively trained for the associated use case or intended tasks.

In some embodiments, quality evaluation service 600 evaluates the scope of coverage based on using distance metrics to measure the similarity between the corpus and the ground truth dataset (e.g., set of Q/A pairs). The system can convert both the corpus and the ground truth dataset into vector representations using techniques like term frequency-inverse document frequency (TF-IDF) or word embeddings (e.g., Word2Vec, glove, BERT, etc.), and use one or more metrics to quantify how well the ground truth dataset (e.g., the set of Q/A pairs) represents the corpus. Examples of the one or more metrics that can quantity how well the ground truth dataset represents the corpus include Hamming techniques (e.g., a computation of the proportion of character positions at which two strings differ), cosine similarity (e.g., a computation of the cosine of the angle between two vectors representing the frequencies of terms in the text), Mikowski techniques (e.g., a family of metrics that includes the Manhattan distance (L1 norm) and the Euclidean distance (L2 norm)), Euclidean distance, Kullback-Leibler divergence (e.g., a measure of the difference between two probability distributions), Jensen-Shannon divergence (e.g., a measure of the similarity between two probability distributions), a Wasserstein metric (e.g., a computation of the minimum cost of transforming one distribution into another), word mover's distance, etc. Higher similarity or lower distance values indicate better coverage, thereby helping the system to identify gaps where the question-answer set may not adequately reflect the corpus content.

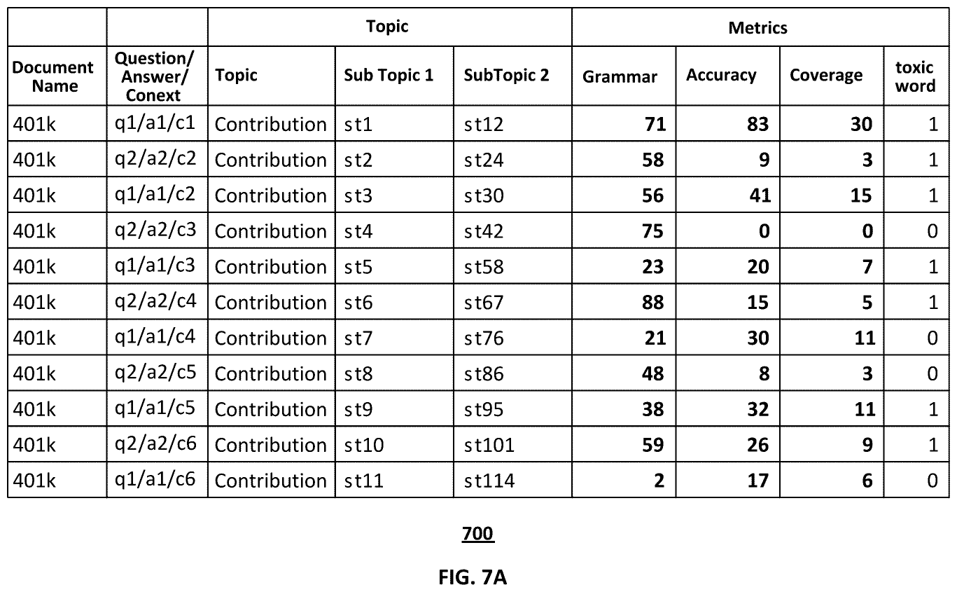

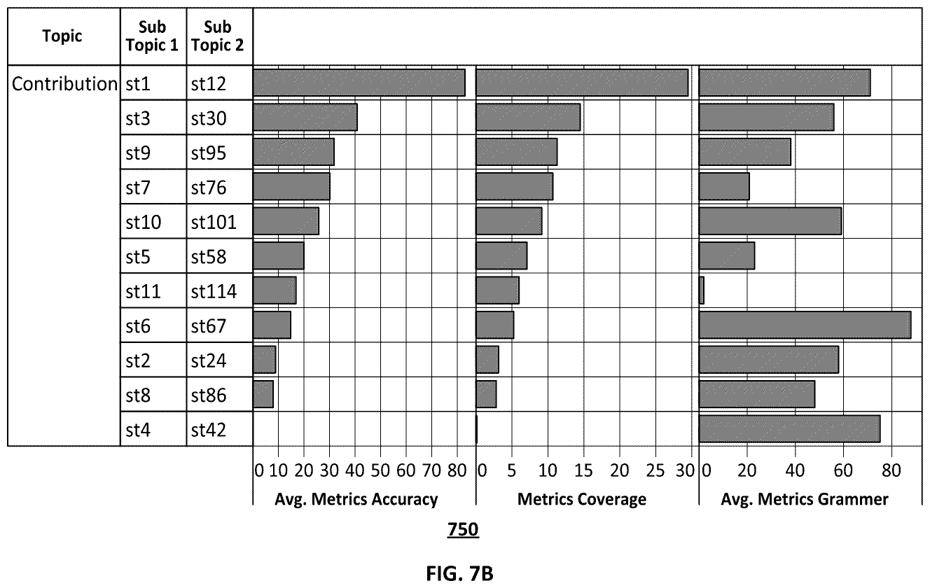

These evaluations allow the system to systematically improve the question-answer pairs, ensuring both high quality and comprehensive coverage. Quality evaluation service 600 may additionally generate visualizations using dimensionality reduction techniques like t-distributed stochastic neighbor embedding (t-SNE) or principal component analysis (PCA) to highlight user clusters of well-covered or underrepresented topics. Examples of visualizations that may be implemented include representation 700 and 750 of FIGS. 7A and 7B.

To perform these evaluations, quality evaluation service 600 can first process both the corpus and the ground truth dataset (e.g., the set of Q/A pairs) to generate their vector representations. For instance, using TF-IDF, each document or question-answer pair is represented as a vector where each dimension corresponds to a term's weighted frequency. As another example, the system implements a Bag of Words (BOW) technique to represent text as a vector of term frequencies. As another example, the system implements a landscape level technique (LSI) which reduces the dimensionality of a BOW representation using singular value decomposition.

Alternatively, quality evaluation service 600 can use word embeddings to provide dense vector representations that capture semantic relationships between words. Once the vectors are obtained, quality evaluation service 600 computes the chosen (or pre-configured) distance metrics to quantify similarity. As an illustrative example, after calculating the cosine similarity between the corpus vector and the question-answer vector, quality evaluation service 600 may find a value of 0.85, indicating high similarity and suggesting that the questions and answers cover most of the corpus content. If the cosine similarity were significantly lower, such as 0.5, the cosine similarity metric would imply that substantial portions of the corpus are not represented in the question-answer set, prompting further generation of questions and answers in those areas. The threshold(s) used to determine whether the ground truth dataset sufficiently covers the corpus may be configurable, such as by an administrator or other user (e.g., an SME).

At 615, quality evaluation service 600 implements one or more predefined thresholds in connection with determining whether a Q/A pair is a high quality Q/A pair, or alternatively, a low-quality Q/A pair. As an example, quality evaluation service 600 can use the one or more predefined thresholds to determine whether the answer adequately addresses the question. These thresholds could be set automatically, or manually by a user, based on empirical data or expert knowledge while setting up the system.

In response to determining at 615 that the initial coverage evaluation does not satisfy the predefined criteria, such as the one or more predefined thresholds or other criteria defined/desired by a user, Quality evaluation service 600 can implement 620 at which the system can enable (e.g., prompt the user or otherwise configure a user interface) a user to select one or more predefined thresholds. Quality evaluation service 600 can then re-run the Q/A evaluation. At 630, quality evaluation service 600 can identify user selected content, such as content that a user has identified as being insufficiently covered. The user can set a new threshold to be achieved for each of the metrics they are interested in. The system compares the metrics in the final set of Q/A pairs to the metrics from quality evaluation service 600.

In response to determining at 615 that the initial coverage evaluation does not satisfy the predefined criteria, such as the one or more predefined thresholds or other criteria defined/desired by a user, quality evaluation service 600 can implement 625 at which the system identifies missed content (e.g., content in the corpus not adequately covered by the ground truth dataset). As an example, in cases where the answer falls short, the system can delve deeper to pinpoint the specific aspects of the question's context that were not adequately covered in the answer. This information can be used by the system to improve the answer generation process.

At 635, quality evaluation service 600 can invoke the generation of new Q/A pairs or update the Q/A pairs deemed to be low quality (e.g., Q/A pairs for which the answer is determined to not sufficiently cover the question). In some embodiments, quality evaluation service 600 invokes Q/A generation service 500 to generate/update the Q/A pairs.

If the metrics in the final set of Q/A pairs meet or exceed the metrics from the quality stage, then the final set of Q/A pairs is considered to be complete and accurate. If the metrics in the final set of Q/A pairs do not meet or exceed the metrics from the quality stage, then the final set of Q/A pairs is sent back to the system with new thresholds, such as to Q/A generation service 500 for the generation of additional Q/A pairs or update existing Q/A pairs.

In some embodiments, the system configures a user interface to enable the user to view the performance of the first machine learning model (e.g., the target LLM) or to visualize metrics pertaining to the ground truth dataset, such as Q/A pairs.

FIGS. 7A and 7B are diagrams of representations of ground truth evaluations according to various embodiments. Representations 700 and/or 750 are implemented by system 100.

In the example shown in FIGS. 7A and 7B, the system provides a user interface that comprises representation 700 and/or representation 750, which presents a table in a user-friendly and intuitive manner. Representation 700 comprises an indication of one or more metrics for one or more Q/A pairs. Representation 700 may further comprise an indication of a particular document or type of document for which the Q/A pair is generated (e.g., for which the Q/A pair is intended to provide coverage). Representation 750 may further comprise an indication of a topic and/or one or more sub-topics. The user interface may enable users to be able to easily identify and select the topic-level ground truth they wish to provide feedback on. For example, the system may configure the user interface to include one or more elements via which the user can provide feedback on the ground truth dataset or a particular Q/A pair. For example, the system may configure the user interface to include selectable elements or options such as “good/bad” or “thumbs up/down” to enable users to indicate their assessment of the ground truth's accuracy. Additionally, the system can configure the user interface to enable a user to delve deeper into individual questions and answers within each topic to provide more granular feedback. This feedback can be used in connection with refining the Q/A generation process, allowing the system to learn from user input and improve the quality of future generations. Based on the feedback received, the system can be re-triggered to generate new Q/A pairs with enhanced targets. The system can use user feedback to enable continuous improvement and optimization of the Q/A generation process.

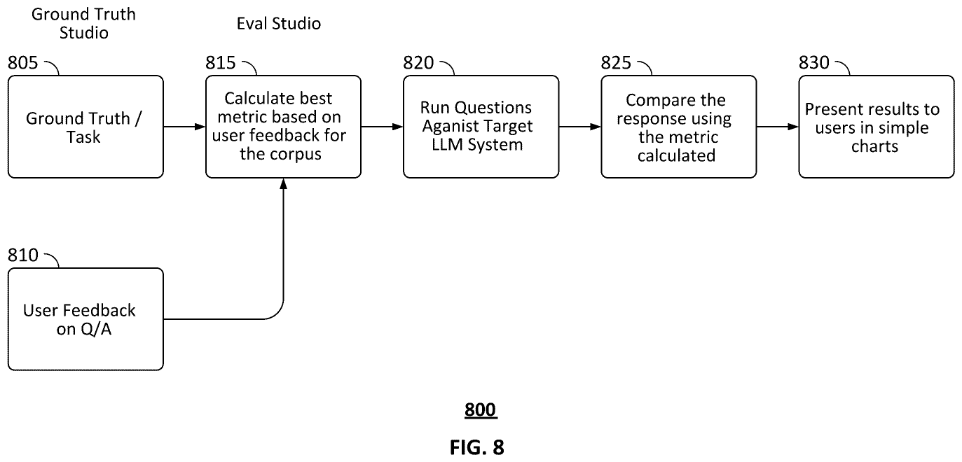

FIG. 8 is a block diagram of a ground truth evaluation service according to various embodiments. In some embodiments, evaluation service 800 implements at least part of system 100. For example, evaluation service 800 can implement at least part of evaluation service 115 of model implementation service 110. In some embodiments, evaluation service 800 implements at least part of one or more of processes 1300, 1400, 1800, and/or 2000 of FIGS. 13, 14, 18, and 20.

According to various embodiments, the system can configure and provide visual representations of an evaluation of the ground truth dataset. As an example, the visual representation enables the user to evaluate the performance of the LLM, and to focus on any task selected by the user, such as accuracy, bias, and toxicity etc. The system can incorporate feedback to refine the evaluation metrics.

At 805, evaluation service 800 obtains the ground truth dataset. For example, evaluation service 800 obtains the Q/A pairs, such as the final set of Q/A pairs obtained by Q/A generation service 500.

At 810, evaluation service 800 obtains user input pertaining to the ground truth dataset. For example, evaluation service 800 obtains user feedback pertaining to the Q/A pairs.

At 815, evaluation service 800 determines a metric to be implemented. In some embodiments, evaluation service 800 calculates the best metric based at least in part on user feedback for the corpus. The system analyzes the user feedback to determine the most appropriate metric or combination of metrics for assessing the LLM's performance. The selection and user of the metric or combination of metrics ensures the evaluation is tailored to the specific corpus and use case.

In some embodiments, evaluation service 800 implements a custom function by treating the user label as the dependent variable and all the computed metrics as predictor variables. The custom function can be expressed as Equation (1) below.

$$Y = b + m 1 X 1 + m 2 X 2 + m 3 X 3 + m 4 X 4 + … \qquad ( 1 )$$

where:
   Y represents the user label;
   X1, X2, X3, X4, . . . represent the predictor variables, which are the metrics computed by evaluation service 800;
   b represents the intercept of the function; and
   m1, m2, m3, m4, . . . represent the slopes of the function.

According to various embodiments, evaluation service 800 solves the custom function, such as the function represented by Equation (1), using a machine learning technique. Examples of machine learning techniques that could be used include Linear & Logistic Regression, Deep Learning and Boosting methods, etc.

At 820, evaluation service 800 runs the ground truth dataset against the first machine learning model (e.g., the target LLM being trained for the use case). For example, evaluation service 800 queries the first machine learning model based on a set of questions comprised in the ground truth dataset. Evaluation service 800 obtains the answers or responses from the first machine learning model.

At 825, evaluation service 800 compares the response using the computed metric. For example, the answers generated by the first machine learning model are compared against the expected answers or the ground truth (e.g., the answers in the Q/A pairs comprised in the ground truth dataset) using the custom metric. The computation based on the response and metric quantifies the performance of the first machine learning model in terms of selected tasks like accuracy, bias, and toxicity.

At 830, evaluation service 800 provides evaluation results to a user. For example, evaluation service 800 can configure a user interface to present results to users, such as in simple or easy to understand charts, tables, or other representations. The evaluation results can be visualized and presented to users in an easily understandable format, such as charts or graphs. This facilitates a clear and intuitive understanding of the strengths and weaknesses of the first machine learning model, or the performance of the first machine learning model for the use case (e.g., in relation to the corpus).

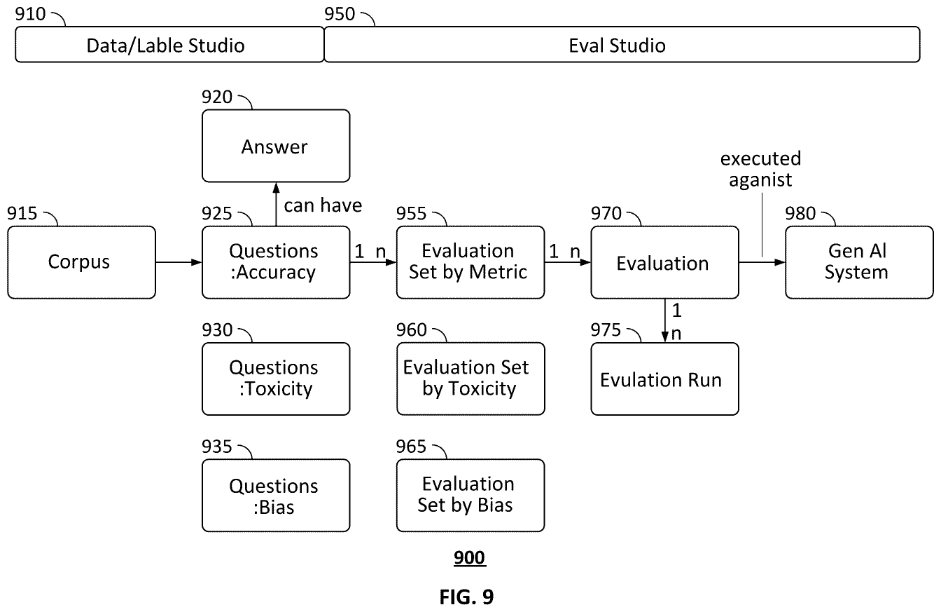

FIG. 9 is a block diagram of a user interface service for configuring an organization-specific model according to various embodiments. In some embodiments, user interface service 900 implements at least part of system 100. For example, user interface service 900 can implement at least part of model implementation service 110.

In the example shown, user interface service 900 comprises a data/label service 910 and an evaluation service 950, which are respectively used to configure user interfaces to be provided to a user through the workflow of training a target machine learning model (e.g., the first machine learning model).

At 915, data/label service 910 configures a user interface to provide information pertaining to the corpus. For example, the user interface can be configured to enable a user to define a corpus, such as to select a use case dataset or to input one or more locations from which documents or files for the use case dataset can be obtained.

In some embodiments, data/label service 910 configures one or more user interfaces that pertain to questions. For example, the use interfaces are configured to enable users to create and manage various question sets. Each question set can comprise a series of questions or prompts relevant to the task or use case. In response to the question sets being defined, data/label service 910 configures user interface(s) via which the users can choose to run the evaluations manually or set up a schedule for automatic execution. In response to the user's selection of a manual option, the system is to provide immediate (e.g., contemporaneous or real-time) feedback, allowing users to observe the responses received from the target machine learning model and to make adjustments to the evaluation process as needed. In contrast, the automatic scheduling feature enables users to specify a schedule for running the evaluations (e.g., to define a recuring schedule such as according to a predefined frequency). This feature is particularly useful for monitoring the LLM's performance over time, tracking its progress, and identifying areas where improvement is required

In the example shown, at 925, data/label service 910 configures a user interface for an evaluation of the set of questions along an accuracy dimension. At 930, data/label service 910 configures a user interface for an evaluation of the set of questions along a toxicity dimension. At 935, data/label service 910 configures a user interface for an evaluation of the set of questions along a bias dimension. At 920, data/label service 910 configures a user interface pertaining to answers associated with the ground truth dataset, such as answers generated by the target machine learning model based on being prompted/trained using the ground truth dataset.

The evaluation results are stored in detailed reports that provide insights into the strengths and weaknesses of the target machine learning model (e.g., the first machine learning model). In some embodiments, evaluation service 950 configures one or more user interfaces pertaining to the evaluation of a ground truth dataset or a target machine learning model. At 955, evaluation service 950 configures and provides a user interface pertaining to an evaluation set along a metric. At 960, evaluation service 950 configures and provides a user interface pertaining to an evaluation set along a toxicity metric/dimension. At 965, evaluation service 950 configures and provides a user interface pertaining to an evaluation set along a bias metric/dimension. At 970, evaluation service 950 configures and provides a user interface pertaining to performing an evaluation against a target machine learning model. At 975, evaluation service 950 configures and provides a user interface pertaining to information associated with an evaluation run, such as results to an evaluation of the target machine learning model, etc. At 980, evaluation service 950 configures and provides a user interface pertaining to the target machine learning model.

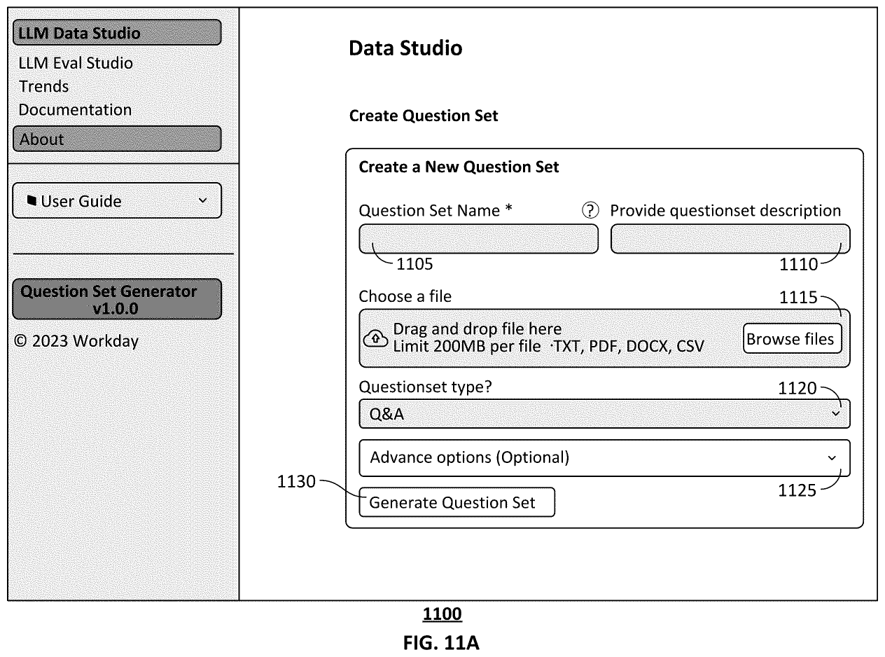

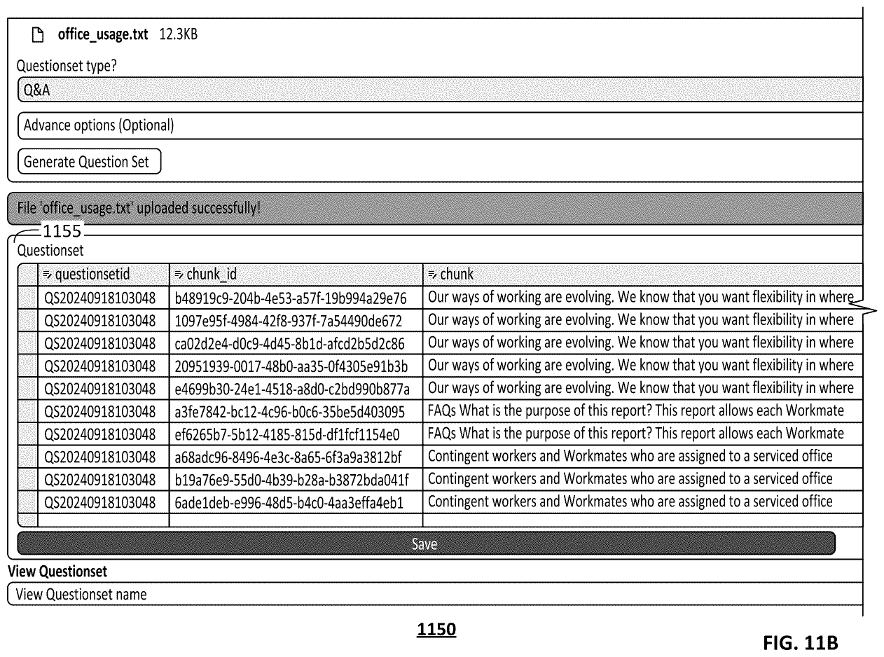

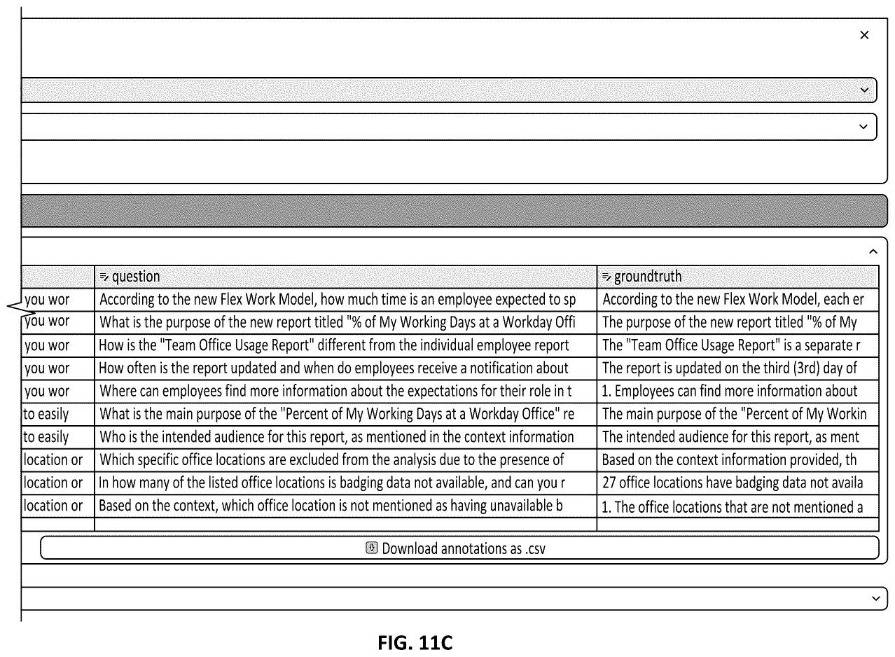

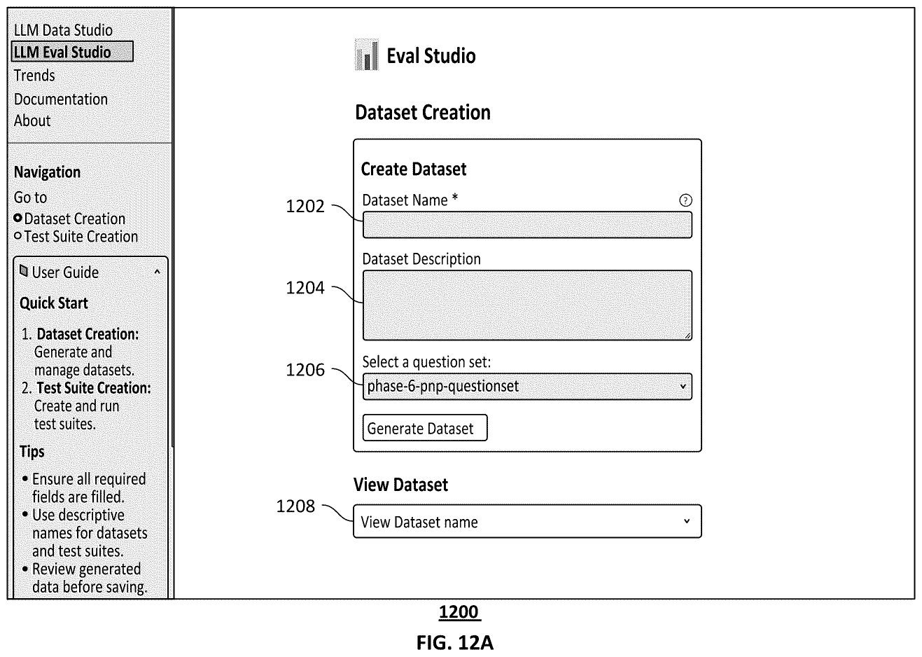

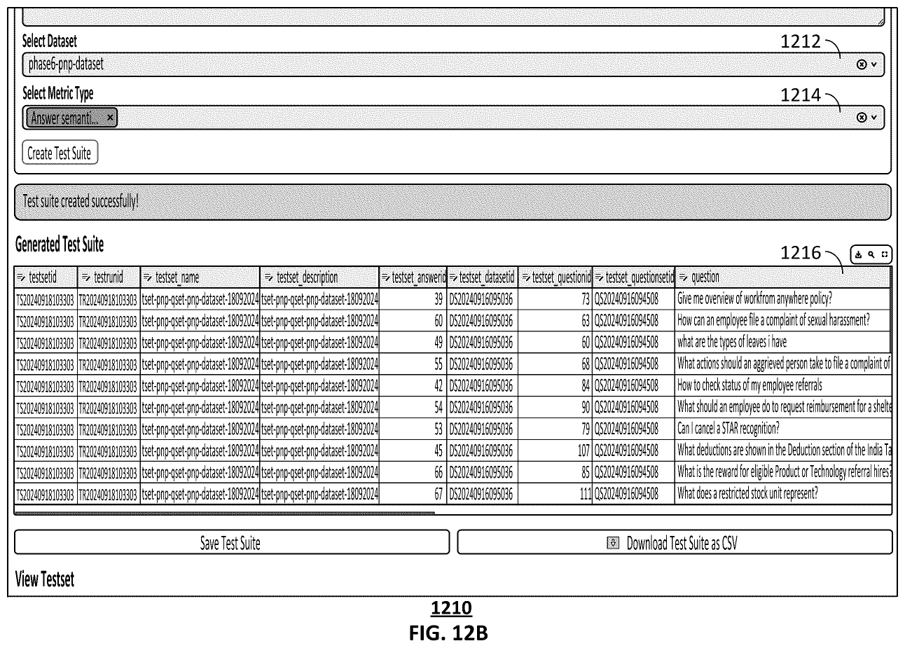

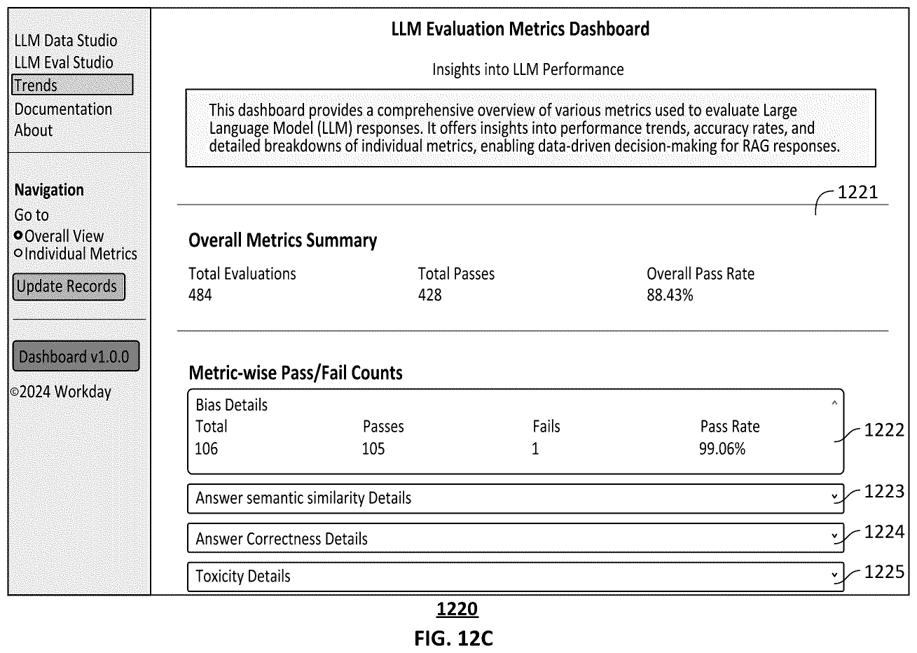

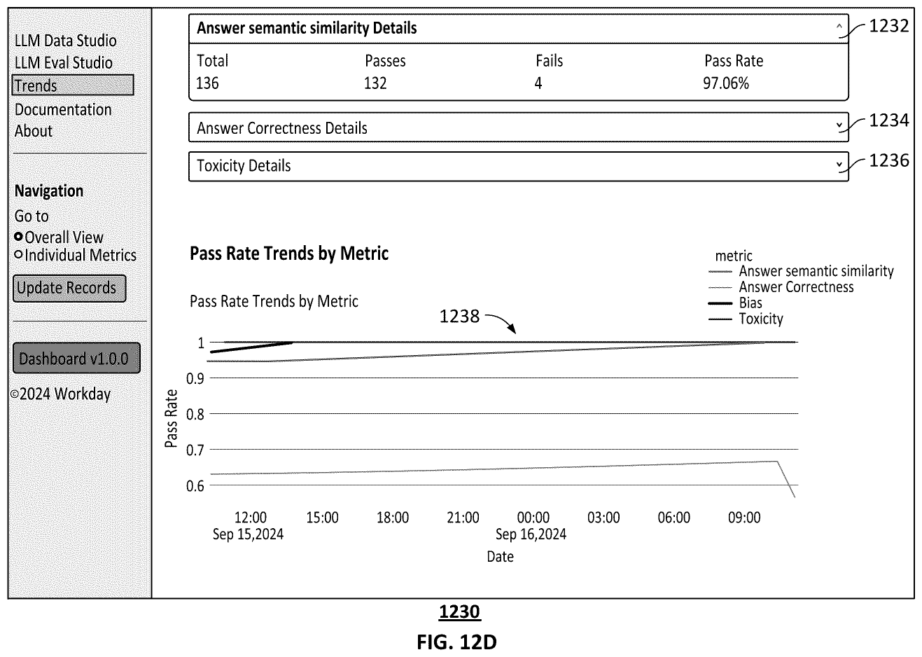

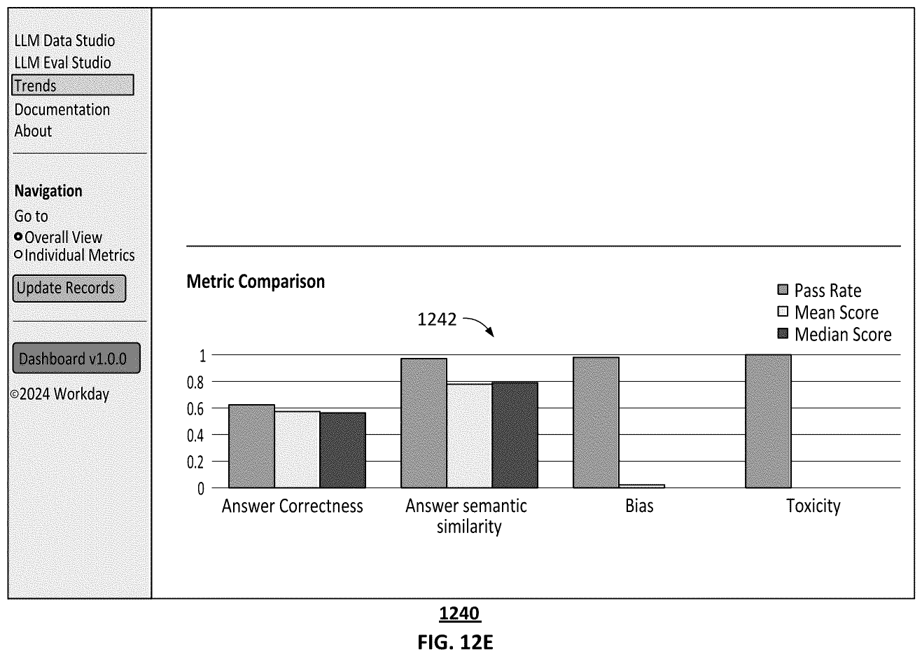

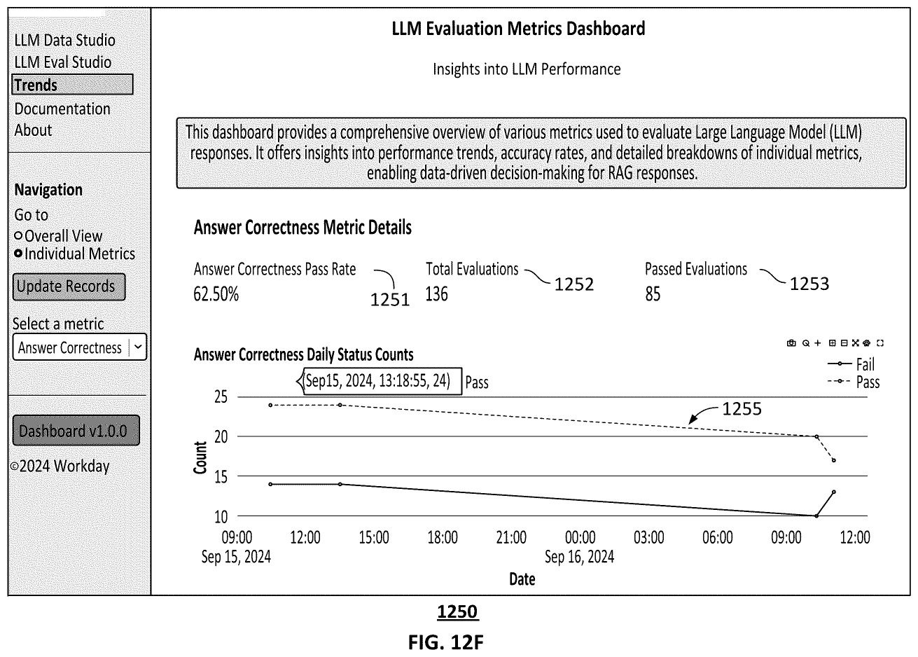

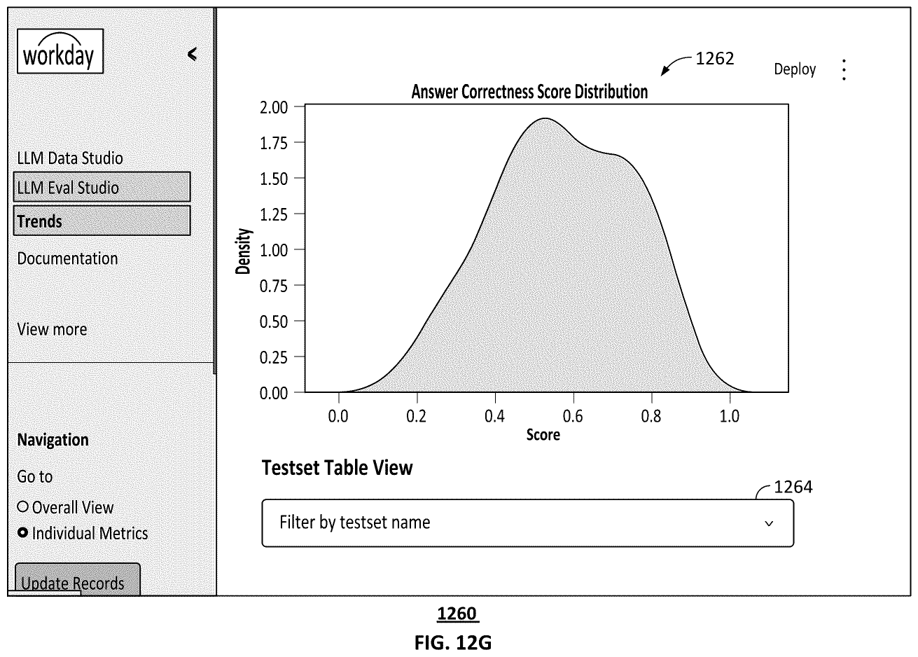

In some embodiments, the user interface is mapped to an entity relationship diagram, wherein the entity relationship diagram shows how data is persisted in the backend. In various embodiments, the user interface comprises 1100 of FIG. 11A or 1200 of FIG. 12A.

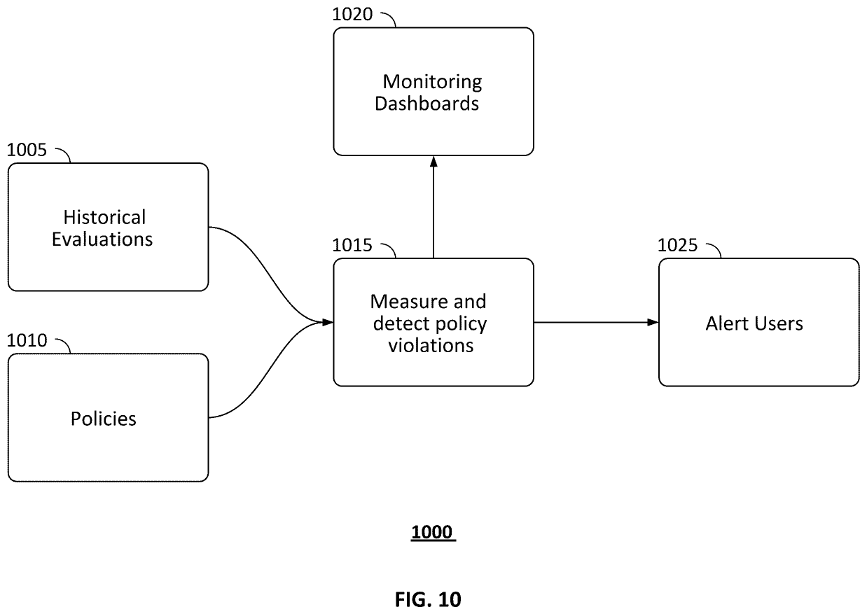

FIG. 10 is a block diagram of a reporting and monitoring service for evaluating a model according to various embodiments. In some embodiments, reporting service 1000 implements at least part of system 100. For example, reporting service 1000 can implement at least part of model deployment service 119 of model implementation service 110.

According to various embodiments, reporting service 1000 can monitor the performance of machine learning models (e.g., models being trained, models that have been deployed, etc.) and generate evaluation results for the machine learning model, such as in the form of generating reports or representations. In some embodiments, reporting service 1000 enables users to define and monitor various policies related to the performance and behavior of the machine learning model(s).

At 1005, reporting service 1000 obtains one or more historical evaluations, such as an evaluation of the machine learning model being monitored.

At 1010, reporting service 1000 obtains one or more policies from a user. The reporting service 1010 can configure a user interface via which a user can input one or more settings or configurations for one or more policies. Users can define custom policies that specify desired performance metrics and thresholds. Examples of policies include: (a) the accuracy measure is to be equal to or greater than 80%, (b) a toxicity measure should be kept at 0%; and (c) a bias is to be less than 1%. Various other policies (e.g., metrics or thresholds) can be implemented.

At 1015, reporting service 1000 measures and detects policy violations. For example, reporting service 1000 can implement a rule engine that continuously monitors the defined policies and the performance of the monitored machine learning model relative to the one or more metrics along which the machine learning model is evaluated. Reporting service 1000 uses one or more evaluation metrics to evaluate the monitored machine learning model's compliance with each policy.

At 1020, reporting service 1000 configures one or more monitoring dashboards, which may provide an indication of an evaluation or performance of the monitored machine learning model. The system can provide the evaluation results in simple trend charts. These charts enable users to easily track the performance of the monitored machine learning model system over time.

At 1025, reporting service 1000 can provide an indication to a user. For example, reporting service 1000 can provide an alert to a user in response to determining that the monitored machine learning model violates a predefined policy, such as in the case that the machine learning model is operating outside the predefined boundaries (e.g., introducing bias, being inaccurate, etc.). Reporting service 1000 may comprise a notification system that alerts users whenever policy thresholds are breached. This alerting mechanism allows for prompt action to address any deviations from the desired performance levels.

FIGS. 11A-11C are user interfaces configured in connection with determining a ground truth for a set of documents or files according to various embodiments. FIG. 11C is an extension of the user interface provided in FIG. 11B.

In the example shown in FIG. 11A, user interface 1100 enables a user to cause the system to generate a ground truth dataset. For example, user interface 1100 enables the user to request that a set of Q/A pairs be generated. User interface 1100 comprises one or more fields, such as (a) field 1105 in which the user can define a question or use case name, (b) field 1110 in which a user can input a description of the ground truth dataset to be generated (e.g., the set of Q/A pairs to be generated), (c) field 1115 in which the user can provide a use case dataset pertaining to the use case or task for which a machine learning model is to be deployed, (d) field 1120 in which the user can define the type of ground truth dataset to be generated (e.g., a Q/A pair, a set of questions, etc.), (e) field 1125 to select advanced options pertaining to the generation of the ground truth dataset, and (f) selectable element 1130 via which the user can request that the ground truth dataset be generated or updated. In some embodiments, the advanced options are coverage, grammar and accuracy thresholds, a customizable LLM prompt and LLM related metrics like temperature etc.

In some embodiments, the user may provide the use case dataset via a dragging and dropping of a set of documents or files to field 1115. In some embodiments, the user may provide the use case dataset via the input of one or more locations from which the documents or files can be obtained.

In the example shown in FIGS. 11B-11C, user interface 1150 comprises field 1155 via which information pertaining to a ground truth dataset is provided. As an example, the ground truth dataset for which information is provided in field 1155 may be a question set generated in response to the user requesting the ground truth dataset be generated via selectable element 1130.

FIGS. 12A-12G are user interfaces configured in connection with determining a ground truth for a set of documents or files according to various embodiments. According to various embodiments, user interfaces 1200, 1210, 1220, 1230, 1240, 1250, and 1260 are implemented by system 100 of FIG. 1 or user interface service 900 of FIG. 9.

In the example shown in FIG. 12A, user interface 1200 enables a user to cause the system to generate a ground truth dataset. For example, user interface 1200 enables the user to request that a set of questions be generated. User interface 1200 comprises one or more fields, such as (a) field 1202 in which the user can define a ground truth dataset name, (b) field 1204 in which a user can input a description of the ground truth dataset to be generated, (c) field 1206 in which the user can provide an indication of a set of questions (or Q/A pairs) to be used to determine a ground truth dataset, and (d) field 1208 in which the user select a ground truth dataset to view or for which information such as evaluation results is to be obtained.

In the example shown in FIG. 12B, user interface 1210 enables a user to cause the system to generate a dataset such as a set of questions (or Q/A pairs) or the ground truth dataset. For example, user interface 1210 enables the user to request that a set of questions be generated. User interface 1210 comprises one or more fields, such as (a) field 1212 in which the user selects a dataset (e.g., a use case dataset) for which a set of questions or ground truth dataset is to be determined, (b) field 1214 in which a user can select one or more metrics or types of metrics along which the generated ground truth dataset is to be created, (c) a selectable element that the user can select to cause the system to generate the ground truth dataset, and (d) field 1216 in which information pertaining to the generated ground truth dataset is displayed.

In the example shown in FIG. 12C, user interface 1220 enables a user to view evaluation results for a particular machine learning model, such as a machine learning model being trained (e.g., the first machine learning model) or a machine learning model that has been deployed. For example, user interface 1220 provides an indication of one or more metrics pertaining to the performance of the machine learning model for which results are being viewed. User interface 1220 comprises one or more fields, such as (a) field 1221 which is an overall summary of results along one or more metrics (e.g., the metrics along which the model is evaluated), (b) field 1222 in which a user can view a set of results from evaluating one or more bias metrics, (c) field 1223 in which a user can view a set of results from evaluating semantic similarities, (d) field 1224 in which a user can view a set of results from evaluating one or more accuracy metrics, and (e) field 1225 in which a user can view a set of results from evaluating one or more toxicity metrics.

In the example shown in FIG. 12D, user interface 1230 enables a user to view evaluation results for a particular machine learning model, such as a machine learning model being trained (e.g., the first machine learning model) or a machine learning model that has been deployed. For example, user interface 1230 provides an indication of one or more metrics pertaining to the performance of the machine learning model for which results are being viewed. User interface 1230 comprises one or more fields, such as (a) field 1232 in which the user has selected to view results from evaluating along semantic similarity metrics, (b) field 1234 in which a user can view a set of results from evaluating one or more accuracy metrics, and (c) field 1236 in which a user can view a set of results from evaluating one or more toxicity metrics. User interface 1230 may be further configured to provide a representation (e.g., a graph) of a trend in the machine learning model performance along a selected metric(s). In the example shown, the chart illustrates trends for the performance along the semantic similarity metrics, the accuracy metrics, the bias metrics, and the toxicity metrics. The trend is illustrated as a function of time.

In the example shown in FIG. 12E, user interface 1240 enables a user to view evaluation results for a particular machine learning model, such as a machine learning model being trained (e.g., the first machine learning model) or a machine learning model that has been deployed. In the example shown, user interface 1240 presents a chart 1242 in which a set of metric comparisons are provided.

In the example shown in FIG. 12F, user interface 1250 enables a user to view evaluation results for a particular machine learning model, such as a machine learning model being trained (e.g., the first machine learning model) or a machine learning model that has been deployed. In the example shown, user interface 1250 provides evaluation results for the performance of the machine learning model along one or more accuracy metrics. For example, user interface 1250 comprises field 1251 indicating results for an answer correctness pass rate (e.g., a percentage of questions for which the model is queried using the ground truth dataset that the model has answered correctly, or where the accuracy exceeds a predefined accuracy threshold). As another example, user interface 1250 comprises field 1252 in which a total number of evaluations is provided. As another example, user interface 1250 comprises field 1253 in which an indication of a number of passed evaluations is presented. In the example shown, user interface 1250 presents a chart 1255 in which a trend of the performance of a machine learning model is evaluated along an accuracy metric(s).

In the example shown in FIG. 12G, user interface 1260 enables a user to view evaluation results for a particular machine learning model, such as a machine learning model being trained (e.g., the first machine learning model) or a machine learning model that has been deployed. In the example shown, user interface 1260 illustrates a representation (e.g., a chart or graph) of the performance of the machine learning model as evaluated according to an accuracy metric(s). For example, user interface 1260 illustrates chart 1262 which indicates a distribution of an evaluation result along an accuracy metric (e.g., a distribution of the accuracy score is displayed). User interface 1260 may further comprise field 1264 in which the user can select a dataset to be viewed.

FIG. 13 is a flow diagram of a method for deploying a machine learning model for a particular use case according to various embodiments. In some embodiments, process 1300 is implemented at least in part by system 100 of FIG. 1 such as by model implementation service 110.

At 1305, the system obtains a use case dataset for which a first machine learning model is to be configured. At 1310, the system obtains a ground truth dataset for configuring the first machine learning model. At 1315, the system configures the first machine learning model based at least in part on the ground truth dataset. The configuring the first machine learning model may include querying the first machine learning model based at least in part on the ground truth dataset, evaluating the first machine learning model along one or more metrics, and updating a configuration of the machine learning model based on an evaluation along the one or more metrics. At 1320, the system deploys the first machine learning model. At 1330, a determination is made as to whether process 1300 is complete. In some embodiments, process 1300 is determined to be complete in response to a determination that no further models are to be deployed, no further models are to be configured (e.g., trained), an administrator indicates that process 1300 is to be paused or stopped, etc. In response to a determination that process 1300 is complete, process 1300 ends. In response to a determination that process 1300 is not complete, process 1300 returns to 1305.

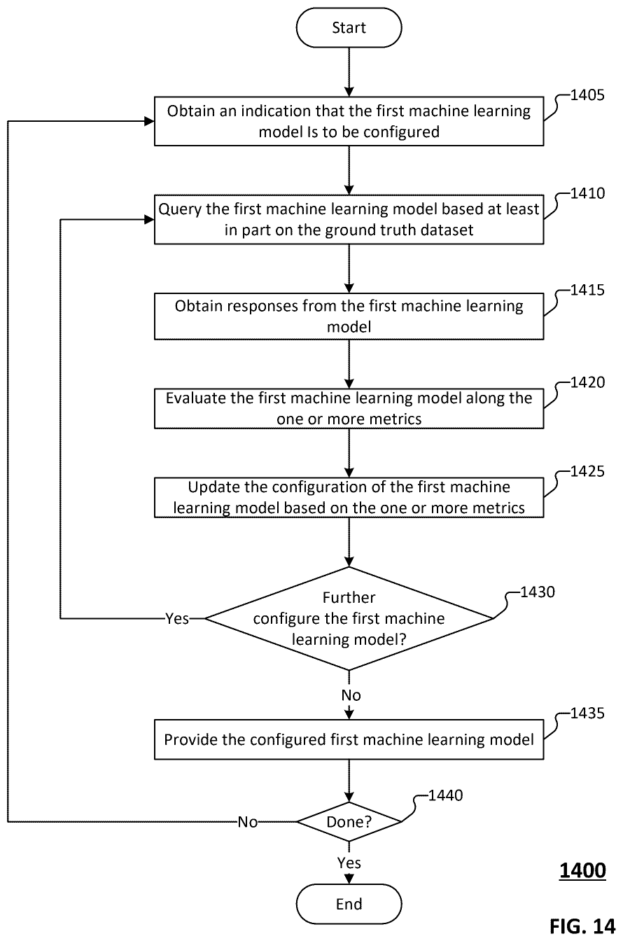

FIG. 14 is a flow diagram of a method for training a first machine learning model to be deployed for a particular use case according to various embodiments. In some embodiments, process 1400 is implemented at least in part by system 100 of FIG. 1 such as by model implementation service 110. Process 1400 may be invoked by 1315 of process 1300.

At 1405, the system obtains an indication that the first machine learning model is to be configured. At 1410, the system queries the first machine learning model based at least in part on the ground truth dataset. At 1415, the system obtains responses from the first machine learning model. At 1420, the system evaluates the first machine learning model along one or more metrics. At 1425, the system updates the configuration of the machine learning model based on the one or more metrics. At 1430, the system determines whether the first machine learning model is to be further configured. For example, the system determines whether the first machine learning model satisfies one or more predefined criteria or thresholds, such as whether the performance of the first machine learning model satisfies one or more predefined criteria along one or more metrics. In response to determining that the first machine learning model is to be further configured, process 1400 returns to 1410 and additional portions of the ground truth dataset (or additional questions generated for the ground truth dataset) are to be used to query the first machine learning model. Process 1400 iterates over 1410-1430 until no further first machine learning models are to be trained. In response to determining that the first machine learning model is not to be further configured, process 1400 proceeds to 1435 at which the system provides the configured first machine learning model. At 1440, a determination is made as to whether process 1400 is complete. In some embodiments, process 1400 is determined to be complete in response to a determination that no further models are to be deployed, no further models are to be configured (e.g., trained), an administrator indicates that process 1400 is to be paused or stopped, etc. In response to a determination that process 1400 is complete, process 1400 ends. In response to a determination that process 1400 is not complete, process 1400 returns to 1405.

FIG. 15 is a flow diagram of a method for determining a ground truth dataset for a particular use case according to various embodiments. In some embodiments, process 1500 is implemented at least in part by system 100 of FIG. 1 such as by model implementation service 110. Process 1500 may be invoked by 1310 of process 1300.

At 1505, the system obtains an indication that a ground truth dataset is to be obtained. At 1510, the system obtains a use case dataset, such as based on a user selection or input. At 1515, the system determines a corpus for the use case dataset. For example, the system can implement or invoke corpus service 400 of FIG. 4. At 1520, the system determines a ground truth dataset based at least in part on the corpus. At 1525, the system provides the ground truth dataset. At 1530, a determination is made as to whether process 1500 is complete. In some embodiments, process 1500 is determined to be complete in response to a determination that no further models are to be deployed, no further ground truth datasets are to be generated or determined, an administrator indicates that process 1500 is to be paused or stopped, etc. In response to a determination that process 1500 is complete, process 1500 ends. In response to a determination that process 1500 is not complete, process 1500 returns to 1505.

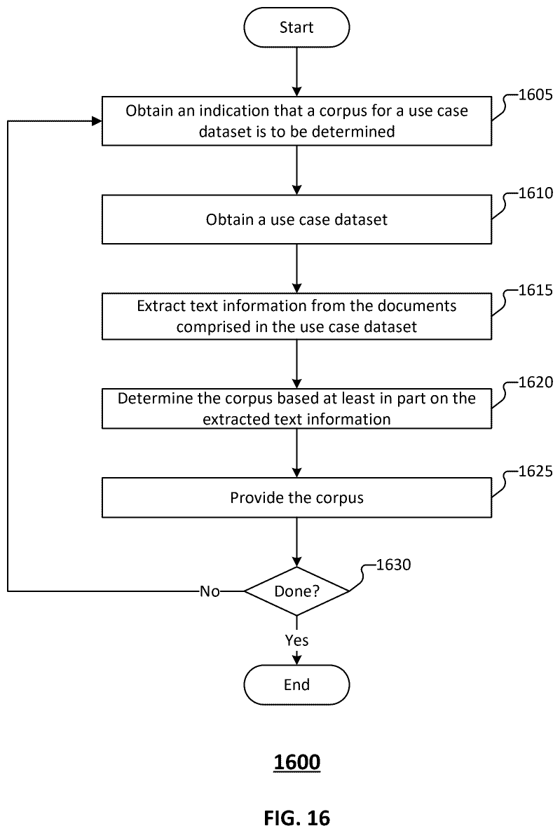

FIG. 16 is a flow diagram of a method for determining a corpus for a particular use case according to various embodiments. In some embodiments, process 1600 is implemented at least in part by system 100 of FIG. 1 such as by model implementation service 110, or by corpus service 400 of FIG. 4. Process 1600 may be invoked by 1515 of process 1500.

At 1605, the system obtains an indication that a corpus for a use case dataset is to be determined. At 1610, the system obtains a use case dataset. At 1615, the system extracts text information from the documents comprised in the use case dataset. At 1620, the system determines the corpus based at least in part on the extracted text information. At 1625, the system provides the corpus. At 1630, a determination is made as to whether process 1600 is complete. In some embodiments, process 1600 is determined to be complete in response to a determination that no further models are to be deployed, no further ground truth datasets are to be generated or determined, no further corpuses are to be determined, an administrator indicates that process 1600 is to be paused or stopped, etc. In response to a determination that process 1600 is complete, process 1600 ends. In response to a determination that process 1600 is not complete, process 1600 returns to 1605.

FIG. 17 is a flow diagram of a method for determining a ground truth dataset for a particular use case according to various embodiments. In some embodiments, process 1700 is implemented at least in part by system 100 of FIG. 1 such as by model implementation service 110. Process 1700 may be invoked by 1310 of process 1300 and/or 1520 of process 1500.

At 1705, the system obtains an indication that a ground truth dataset is to be determined. At 1710, the system obtains the corpus for the use case. At 1715, the system generates a set of question and answer pairs. At 1720, the system evaluates the set of question and answer pairs. The evaluation can be performed automatically, such as programmatically, and/or based on a user input. At 1725, the system determines whether the set of question and answer pairs are sufficient. For example, the system determines whether the set of question and answer pairs sufficiently covers the corpus (e.g., covers the context defined by the corpus) and/or that the set of question and answer pairs satisfy one or more predefined quality criteria, such as evaluated along one or more metrics. In response to determining that the set of question and answer pairs are not sufficient, process 1700 returns to 1715 and process 1700 iterates over 1715-1725 until the set of question and answer pairs are sufficient. In contrast, in response to determining that the set of question and answer pairs are sufficient, process 1700 proceeds to 1730 at which the system provides the ground truth dataset. For example, the system deems the sufficient question and answer pairs as the ground truth dataset. At 1735, a determination is made as to whether process 1700 is complete. In some embodiments, process 1700 is determined to be complete in response to a determination that no further models are to be deployed, no further ground truth datasets are to be generated or determined, an administrator indicates that process 1700 is to be paused or stopped, etc. In response to a determination that process 1700 is complete, process 1700 ends. In response to a determination that process 1700 is not complete, process 1700 returns to 1705.

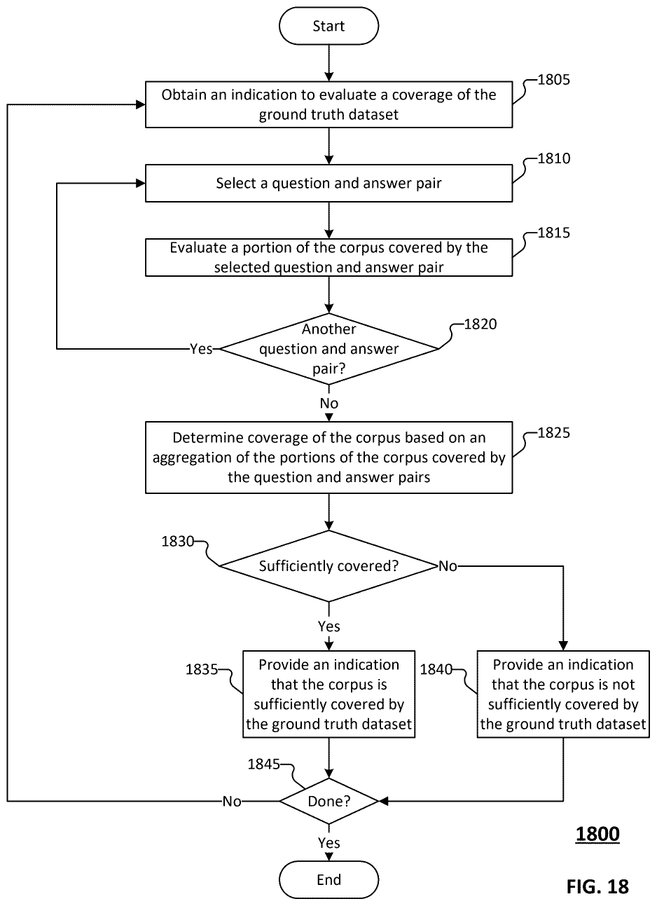

FIG. 18 is a flow diagram of a method for evaluating a ground truth dataset according to various embodiments. In some embodiments, process 1800 is implemented at least in part by system 100 of FIG. 1 such as by model implementation service 110. Process 1800 may be invoked by 1310 of process 1300 and/or 1520 of process 1500.

At 1805, the system obtains an indication to evaluate a coverage of the ground truth dataset. At 1810, the system selects a question and answer pair. At 1815, the system evaluates a portion of the corpus covered by the selected question and answer pair. At 1820, the system determines whether another question and answer pair is to be evaluated to determine its coverage of the corpus (e.g., the context defined by the corpus). In response to determining that another question and answer pair is to be evaluated, process 1800 returns to 1810 and process 1800 iterates over 1810-1820 until no further question and answer pairs are to be evaluated. Conversely, in response to determining that no further question and answer pairs are to be evaluated, process 1800 proceeds to 1825 at which the system determines a coverage of the corpus based on an aggregation of the portions of the corpus (e.g., the context defined by the corpus) covered by the question and answer pairs (e.g., the Q/A pairs evaluated at 1810-1820). At 1830, the system determines whether the corpus is sufficiently covered. For example, the system determines whether a coverage by the set of questions and answer pairs satisfies a predefined coverage threshold. In some embodiments, the predefined coverage threshold corresponds to 100%, for example, the system iterates over the generation of Q/A pairs for the ground truth dataset until the system determines that the corpus (e.g., the context defined by the corpus) is fully covered. In response to determining that the corpus is sufficiently covered, process 1800 proceeds to 1835 at which the system provides an indication that the corpus is sufficiently covered by the ground truth dataset. Conversely, in response to determining that the corpus is not sufficiently covered, process 1800 proceeds to 1840 at which the system provides an indication that the corpus is not sufficiently covered by the ground truth dataset. At 1845, a determination is made as to whether process 1800 is complete. In some embodiments, process 1800 is determined to be complete in response to a determination that no further models are to be deployed, no further ground truth datasets are to be generated or determined, an administrator indicates that process 1800 is to be paused or stopped, etc. In response to a determination that process 1800 is complete, process 1800 ends. In response to a determination that process 1800 is not complete, process 1800 returns to 1805.

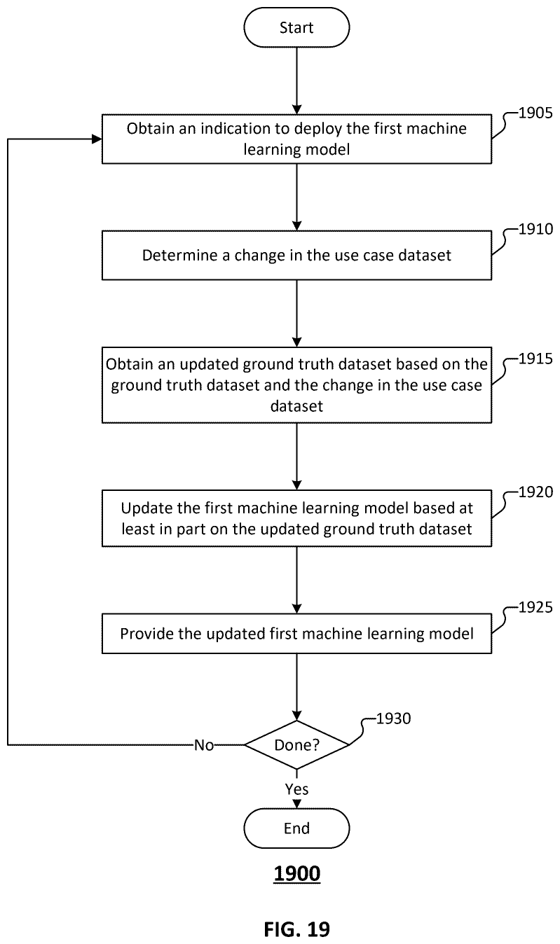

FIG. 19 is a flow diagram of a method for updating a deployed machine learning model according to various embodiments. In some embodiments, process 1900 is implemented at least in part by system 100 of FIG. 1 such as by model implementation service 110. Process 1900 may be invoked by 1320 of process 1300.

At 1905, the system obtains an indication to deploy the machine learning model. At 1910, the system determines a change in the use case dataset. At 1915, the system obtains an updated ground truth dataset based at least in part on the ground truth dataset and the change in the use case dataset. At 1920, the system updates the first machine learning model based at least in part on the updated ground truth dataset. At 1925, the system provides the updated first machine learning model. At 1930, a determination is made as to whether process 1900 is complete. In some embodiments, process 1900 is determined to be complete in response to a determination that no further deployed models are to be monitored, no further deployed models are to be updated, no further updates to the use case dataset are to be determined or evaluated, an administrator indicates that process 1900 is to be paused or stopped, etc. In response to a determination that process 1900 is complete, process 1900 ends. In response to a determination that process 1900 is not complete, process 1900 returns to 1905.

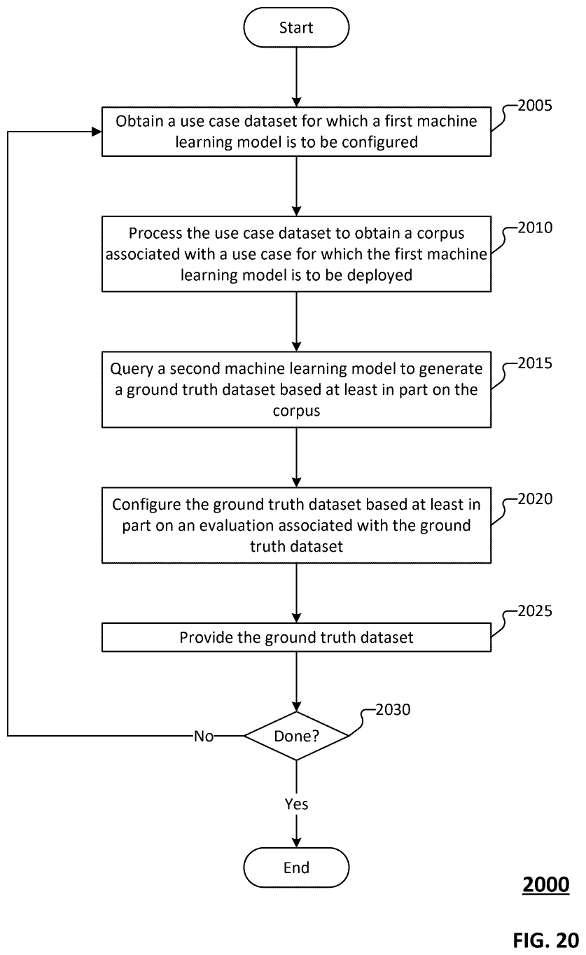

FIG. 20 is a flow diagram of a method for generating a ground truth dataset for a particular use case according to various embodiments. In some embodiments, process 2000 is implemented at least in part by system 100 of FIG. 1 such as by model implementation service 110. Process 2000 may be invoked by 1310 of process 1300 and/or 1520 of process 1500.

At 2005, the system obtains a use case dataset for which a first machine learning model is to be configured. At 2010, the system processes the use case dataset to obtain a corpus associated with a use case for which the first machine learning model is to be deployed. At 2015, the system queries a second machine learning model to generate a ground truth dataset based at least in part on the corpus. At 2020, the system configures the ground truth dataset based at least in part on an evaluation associated with the ground truth dataset. At 2025, the system provides the ground truth dataset. At 2030, a determination is made as to whether process 2000 is complete. In some embodiments, process 2000 is determined to be complete in response to a determination that no further models are to be deployed, no further ground truth datasets are to be determined, an administrator indicates that process 2000 is to be paused or stopped, etc. In response to a determination that process 2000 is complete, process 2000 ends. In response to a determination that process 2000 is not complete, process 2000 returns to 2005.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
obtain a use case dataset for which a first machine learning model is to be configured;
obtain a ground truth dataset for configuring the first machine learning model, the ground truth dataset being obtained based at least in part on querying a second machine learning model based on the use case dataset;
configure the first machine learning model based on the ground truth dataset, wherein configuring the first machine learning model comprises:
querying the first machine learning model based at least in part on the ground truth dataset;
evaluating the first machine learning model along one or more metrics; and
is updating a configuration of the first machine learning model based on an evaluation along the one or more metrics; and
deploy the first machine learning model; and
a memory coupled to the one or more processors and configured to provide the one or more processors with instructions.

2. The system of claim 1, wherein the first machine learning model is a large language model.

3. The system of claim 1, wherein the ground truth dataset comprises a set of questions and answers with which the first machine learning model is to be evaluated in relation to the use case dataset.

4. The system of claim 1, wherein the one or more metrics comprises accuracy.

5. The system of claim 1, wherein the one or more metrics comprises bias.

6. The system of claim 1, wherein the one or more metrics comprises toxicity.

7. The system of claim 1, wherein deploying the first machine learning model comprises:
monitoring performance of the first machine learning model along the one or more metrics; and
updating the first machine learning model based on a monitored performance.

8. The system of claim 7, wherein:
the ground truth dataset provided by the second machine learning model comprises a set of questions associated with a corpus and a set of answers associated with the corpus; and
the monitoring performance of the first machine learning model along the one or more metrics comprises:
querying the first machine learning model based on the set of questions;
receiving, from the first machine learning model, a set of responses to the set of questions; and
evaluating the first machine learning model based at least in part on the set of responses and the set of answers.

9. The system of claim 1, wherein deploying the first machine learning model comprises:
determining a change in the use case dataset;
obtaining an updated ground truth dataset based at least in part on the ground truth dataset and the change in the use case dataset; and
updating the first machine learning model based at least in part on the updated ground truth dataset.

10. The system of claim 1, wherein deploying the first machine learning model comprises:
configuring a user interface to comprise an indication of a performance of the first machine learning model along the one or more metrics; and
causing the user interface to be displayed.

11. The system of claim 1, wherein obtaining the ground truth dataset comprises:
processing the use case dataset to obtain a corpus associated with a use case for which the first machine learning model is to be deployed;
querying the second machine learning model to generate a set of questions and answers associated with the corpus; and
configuring the ground truth dataset based on (i) the set of questions and answers associated with the corpus, and (ii) a user input associated with the set of set of questions and answers associated with the corpus.

12. The system of claim 11, wherein querying the second machine learning model to generate the set of questions and answers associated with the corpus comprises:
extracting an extracted graph that represents the corpus; and
configuring the second learning model based at least in part on the extracted graph.

13. The system of claim 11, wherein the use case dataset comprises a set of documents that are organization specific and associated with the use case.

14. The system of claim 11, wherein processing the use case comprises extracting text from documents or files comprised in the use case dataset.

15. The system of claim 1, wherein deploying the first machine learning model comprises:
monitoring performance of the first machine learning model along the one or more metrics;
is configuring a user interface that indicates a performance of the first machine learning model; and
causing the user interface to be displayed.

16. The system of claim 15, wherein the user interface provides an indication of the performance of the first machine learning model over a predefined period of time.

17. The system of claim 1, wherein the evaluating the first machine learning model along the one or more metrics comprises:
determining a scope of coverage for the first machine learning model in relation to a corpus associated with a use case for which the first machine learning model is to be deployed; and
determining whether the first machine learning model sufficiently covers the corpus based on the scope of coverage.

18. The system of claim 17, wherein:
the ground truth dataset provided by the second machine learning model comprises a set of questions associated with the corpus and a set of answers associated with the corpus; and
the determining the scope of coverage comprises:
querying the first machine learning model based on the set of questions;
obtaining a set of responses obtained from the first machine learning model; and
computing a coverage of the set of questions and the set of responses based at least in part on one or more distance metrics and one or more predefined thresholds.

19. A method, comprising:
obtaining a use case dataset for which a first machine learning model is to be configured;
obtaining a ground truth dataset for configuring the first machine learning model, the ground truth dataset being obtained based at least in part on querying a second machine learning model based on the use case dataset;
configuring the first machine learning model based on the ground truth dataset, wherein configuring the first machine learning model comprises:
querying the first machine learning model based at least in part on the ground truth dataset;
is evaluating the first machine learning model along one or more metrics; and
updating a configuration of the first machine learning model based on an evaluation along the one or more metrics; and
deploying the first machine learning model.

20. A computer program product embodied in a non-transitory computer readable medium and comprising computer instructions for:
obtaining a use case dataset for which a first machine learning model is to be configured;
obtaining a ground truth dataset for configuring the first machine learning model, the ground truth dataset being obtained based at least in part on querying a second machine learning model based on the use case dataset;
configuring the first machine learning model based on the ground truth dataset, wherein configuring the first machine learning model comprises:
querying the first machine learning model based at least in part on the ground truth dataset;
evaluating the first machine learning model along one or more metrics; and
updating a configuration of the first machine learning model based on an evaluation along the one or more metrics; and
deploying the first machine learning model.
